(19) United States
(12) Patent Application Publication
(10) Pub. No.: US 2026/0099107 A1
(43) Pub. Date: Apr. 9, 2026

(54) TONER

(71) Applicant: CANON KABUSHIKI KAISHA, Tokyo (JP)

(72) Inventors: TOHRU HIRAMATSU, Shizuoka (JP); YUU SASANO, Shizuoka (JP); HIROKI KAGAWA, Shizuoka (JP); SHOHEI SHIBAHARA, Shizuoka (JP); KENYA TERADA, Shizuoka (JP); YOSUKE IWASAKI, Chiba (JP); YURI YAMABAYASHI, Chiba (JP)

(21) Appl. No.: 19/346,247

(22) Filed: Sep. 30, 2025

(30) Foreign Application Priority Data
Oct. 8, 2024 (JP) 2024-176793

(51) Int. Cl. G03G 9/093; G03G 9/087

(52) U.S. Cl. CPC G03G 9/09342; G03G 9/08711; G03G 9/09335

(57) ABSTRACT

A toner includes an external additive on a surface of a toner particle. The external additive contains a metal titanate compound fine particle A, a silica fine particle B, and an inorganic fine particle C. A fragment ion corresponding to a dimethylsiloxane structure is observed from the fine particle A. Peaks D, X2, and X3 respectively assigned to D, X3, and X3 unit structures are observed from the fine particle A. An area S_{D} of the peak D, an area S_{X2} of the peak X2, and an area S_{X3} of the peak X3 satisfy a predetermined formula. In the Feret minimum diameter range of 5 to 100 nm, a peak 1 assigned to the fine particle B is observed, and a peak 2 assigned to the fine particle C is observed in the Feret minimum diameter range of 50 to 1000 nm and on the large particle diameter side of the peak 1.

### BACKGROUND

### Field of the Technology

The present disclosure relates to a toner that is used in electrophotographic or electrostatic recording copying machines and printers.

### Description of the Related Art

In recent years, copying machines and printers have become increasingly high-speed and long-life, and environmental stability thereof have also improved.

Toners are required to have stress resistance that can withstand frictions inside the cartridges during long hours of high-speed printing and stable chargeability that does not depend on the service environment.

It is known that adding, to a toner, hydrophobized metal titanate compound fine particles and large-particle-diameter inorganic fine particles as external additives for toners stabilizes charges and imparts good transferability, and as a result, a high-quality image is obtained.

Japanese Patent Laid-Open No. 2015-137208 discloses strontium titanate fine particles treated with a silicone oil or an alkoxysilane as an external additive for toners.

The strontium titanate fine particles are disclosed to be a charge control agent used for toners and having excellent dispersibility and good environmental properties and charge properties.

Japanese Patent Laid-Open No. 2020-129029 discloses that by using a two-component developer containing strontium titanate particles surface-treated with a hydrophobizing agent, pinholes rarely form in photosensitive members and excellent image density stability and fogging resistance are achieved.

Japanese Patent Laid-Open No. 2023-026551 discloses that by using a two-component developer containing metal-doped strontium titanate particles having surfaces hydrophobized with a silicon-containing organic compound, fogging that occurs in the image output immediately after starting an image forming apparatus is suppressed.

However, the aforementioned measures still leave some room for improvement when it comes to long-term use of higher-speed, longer-life copying machines and printers in a high-temperature, high-humidity environment.

### SUMMARY

The present disclosure addresses the issues described above by providing a toner that can maintain charge stability and good transferability and achieve stable image quality even when the toner is used for a long time at a low printing ratio in a high-temperature, high-humidity environment.

An aspect of the present disclosure provides a toner that includes a toner particle comprising a binder resin and a release agent; and an external additive on a surface of the toner particle.

The external additive comprises a metal titanate compound fine particle A, a silica fine particle B, and an inorganic fine particle C. In time-of-flight secondary ion mass spectrometry using the metal titanate compound fine particle A as a sample, a fragment ion corresponding to a structure represented by formula (1) below is observed. In a ²⁹Si-NMR spectrum obtained by a solid-state ²⁹Si-NMR CP/MAS method using the metal titanate compound fine particle A as a sample,
(i) a peak D assigned to a D unit structure is present in a range of −25 ppm to −15 ppm,
(ii) a peak X2 assigned to an X2 unit structure represented by formula (2) below is present in a range of −60 ppm to −50 ppm,
(iii) a peak X3 assigned to an X3 unit structure represented by formula (3) below is present in a range of −70 ppm to −60 ppm, and
(iv) S_{D}/(S_{X2}+S_{X3}) is 0.10 to 1.50 where S_{D} represents an area of the peak D, S_{X2} represents an area of the peak X2, and S_{X3} represents an area of the peak X3. The inorganic fine particle C is a fine particle selected from the group consisting of a silica fine particle C, an alumina fine particle C, and a titania fine particle C. In a graph based on a particle size distribution of silica fine particles obtained by combining SEM image analysis and EDX analysis on a surface of the toner, the graph having a horizontal axis indicating a Feret minimum diameter of primary particles and a vertical axis indicating a frequency, a peak 1 having a peak value in a Feret minimum diameter range of 5 to 100 nm and being mainly constituted by the silica fine particle B is observed. In a graph based on a particle size distribution of the external additive obtained by combining SEM image analysis and EDX analysis on the surface of the toner, the graph having a horizontal axis indicating a Feret minimum diameter of primary particles and a vertical axis indicating a frequency, a peak 2 having a peak value that is present in a Feret minimum diameter range of 50 to 1000 nm and on a large particle diameter side of the peak value of the peak 1, and being mainly constituted by the inorganic fine particle C is observed.

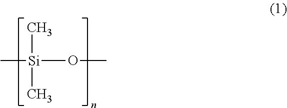

In formula (1), n represents an integer of 2 or more.

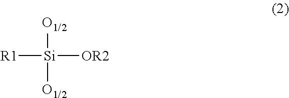

In formula (2), R1 represents a hydrocarbon group having 1 to 0 carbon atoms, R2 represents a hydrogen atom or a hydrocarbon group having 1 to 10 carbon atoms, and O_{1/2} represents an oxygen atom shared with an adjacent Si atom or Ti atom.

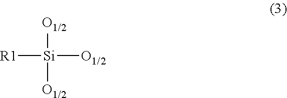

In formula (3), R1 represents a hydrocarbon group having 1 to 10 carbon atoms, and O_{1/2} represents an oxygen atom shared with an adjacent Si atom or Ti atom.

Features of the present disclosure will become apparent from the following description of embodiments. The following description of embodiments is described by way of example.

### DESCRIPTION OF THE EMBODIMENTS

In the present disclosure, phrases indicating numerical ranges, such as “X or more and Y or less” and “X to Y”, are numerical ranges inclusive of end points, that is, the lower limit and the upper limit, unless otherwise noted. When numerical ranges are expressed stepwise, the upper limit and the lower limit of each numerical range can be combined as desired. In the present disclosure, when metal titanate compound fine particle A have been surface-treated with a surface treating agent, the metal titanate compound fine particles including the structures derived from the surface treating agent are referred to as the metal titanate compound fine particle A. The metal titanate compound fine particle A before the surface treatment are referred to as metal titanate compound fine particle bases.

First, the inventors of the present disclosure have focused on the surfaces of the metal titanate compound fine particles. On the surfaces of the metal titanate compound fine particles, some of oxygen atoms bonded to titanium atoms exist as hydroxy groups. Thus, the surfaces of the metal titanate compound fine particles easily adsorb moisture in the air.

Particularly in a high-temperature, high-humidity environment, the amount of the moisture absorbed onto the surfaces of the metal titanate compound fine particles increases, and thus the chargeability of the metal titanate compound fine particles tends to decrease. The method for suppressing the decrease in chargeability involves, for example, hydrophobizing surfaces of metal titanate compound fine particles with a silane coupling agent or a silicone oil. However, according to typical hydrophobizing methods, the amount of hydroxy groups on the surfaces of the metal titanate compound fine particles could not be sufficiently controlled, and thus the charge stability in a high-temperature, high-humidity environment has been insufficient.

When the metal titanate compound fine particles are surface-treated with only a silane coupling agent, silanol groups derived from the silane coupling agent remain on the surfaces of the metal titanate compound fine particles, and thus it is difficult to control the amount of hydroxy groups on the surfaces of the metal titanate compound fine particles. Thus, with the metal titanate compound fine particles that have been surface-treated with only a silane coupling agent, it is difficult for the surfaces of the metal titanate compound fine particles to maintain the hydrophobized state and to control the charged state over a prolonged period of time. The same tendency is observed when two or more silane coupling agents having different alkyl group structures are used in combination.

When surfaces of metal titanate compound fine particles are hydrophobized with only a silicone oil, chemical bonds are rarely formed between the silicone oil and the hydroxy groups on the surfaces of the metal titanate compound fine particles, and thus the silicone oil tends to detach. Thus, when images are output at low printing ratios for a long time, the surfaces of the bases of the metal titanate compound fine particles become exposed, and it is difficult for the surfaces of the metal titanate compound fine particles to maintain the hydrophobized state and to control the charged state.

When images are output for a long time by using metal titanate compound fine particles surface-treated with only a silane coupling agent only or only a silicone oil (hereinafter such particles are referred to as typical metal titanate compound fine particles), the surface treatment on the metal titanate compound fine particles becomes prone to deterioration. The metal titanate compound fine particles with the deteriorated surface treatment have a small electrostatic repulsion force with negatively chargeable inorganic fine particles. Consequently, as the copying machines and printers are used in a high-temperature, high-humidity environment for a long time, the metal titanate compound fine particles with deteriorated surface treatment and the inorganic fine particles form aggregated particles via moisture and are prone to detach from the toner particle. In particular, when images are output for a long time at a low printing ratio, the time for which the toner stays in the developing device becomes longer, and thus the aggregated particles of the metal titanate compound fine particles and the inorganic fine particles tend to accumulate inside the developing device. The accumulated aggregated particles scrape the members such as a developer bearing member and a photosensitive member, and image defects thereby occur (streaks in the image in the sheet feed direction). Moreover, when the aggregated particles are formed, aggregated particles accumulate in a development regulation portion, regulation failure occurs, and image defects (uneven density in halftone images and solid images) occur as a result.

By increasing the amount the treatment of the silane coupling agent or the silicone oil relative to the metal titanate compound fine particles, the number of hydroxy groups present on the surfaces of the metal titanate compound fine particles can be decreased. However, the metal titanate compound fine particles treated with an increased amount of a silane coupling agent or a silicone oil exhibits an increased powder resistivity, and thus the desired charge properties are no longer obtained. Furthermore, the flowability of the toner decreases, and image defects caused by toner aggregation occur.

When typical metal titanate compound fine particles and large-particle-diameter inorganic particles are used in combination as the external additive for the toner, the large-particle-diameter inorganic particles act as spacer particles, and the charge stability and the transferability of the toner improve. However, during the long-term use in a high-temperature, high-humidity environment, the surface treatment of the metal titanate compound fine particles deteriorates, and thus the metal titanate compound fine particles and the large-particle-diameter inorganic particles form aggregated particles and detach from the toner. As a result, the charge stability and the transferability of the toner are significantly compromised.

By further adding silica fine particles having a large specific surface area and high negative chargeability in addition to the typical metal titanate compound fine particles and the large-particle-diameter inorganic particles, the charging stability of the toner is further improved. However, during the long-term use in a high-temperature, high-humidity environment, aggregated particles of the metal titanate compound fine particles and the large-particle-diameter inorganic particles still form as described above. Furthermore, an electrostatic force acts between the positively chargeable metal titanate compound fine particles and the negatively chargeable silica fine particles, and stronger coarse aggregated particles are formed as a result.

When images are output for a long time at a low printing ratio, the time for which the toner resides in the developing device becomes long, and thus the aggregated particles tend to accumulate inside the developing device. The accumulated aggregated particles scrape the members such as a developer bearing member and a photosensitive member, and image defects thereby occur (streaks in the image in the sheet feed direction). Moreover, when the aggregated particles are formed, the aggregated particles accumulate in a development regulation portion, regulation failure occurs, and image defects (uneven density in halftone images and solid images) occur as a result.

The inventors of the present disclosure have conducted extensive studies and found that a toner having the following features can maintain charge stability and good transferability and achieve stable image quality even when the toner is used for a long time at a low printing ratio in a high-temperature, high-humidity environment.

A toner according to the present disclosure includes a toner particle comprising a binder resin and a release agent, and an external additive on a surface of the toner particle, the toner having the following features. The external additive comprises a metal titanate compound fine particle A, a silica fine particle B, and an inorganic fine particle C. In time-of-flight secondary ion mass spectrometry using the metal titanate compound fine particle A as a sample, fragment ions corresponding to a structure represented by formula (1) below are observed, and in a ²⁹Si-NMR spectrum obtained by a solid ²⁹Si-NMR CP/MAS method using the metal titanate compound fine particle A as a sample,
(i) a peak D assigned to a D unit structure is present in the range of −25 ppm to −15 ppm,
(ii) a peak X2 assigned to an X2 unit structure represented by formula (2) below is present in the range of −60 ppm to −50 ppm,
(iii) a peak X3 assigned to an X3 unit structure represented by formula (3) is present in the range of −70 ppm to −60 ppm, and
(iv) S_{D}/(S_{X2}+S_{X3}) is 0.10 to 1.50 where S_{D} represents the area of the peak D, S_{X2} represents the area of the peak X2, and S_{X3} represents the area of the peak X3.

The inorganic fine particle C is a fine particle selected from the group consisting of a silica fine particle C, an alumina fine particle C, and a titania fine particle C.

In a graph based on the particle size distribution of silica fine particles obtained by combining SEM image analysis and EDX analysis on a surface of the toner, the graph having a horizontal axis indicating the Feret minimum diameter of primary particles and a vertical axis indicating the frequency, a peak 1 having a peak value in the 5 to 100 nm Feret minimum diameter range and being mainly constituted by the silica fine particle B is observed.

Furthermore, in a graph based on the particle size distribution of the external additive obtained by combining SEM image analysis and EDX analysis on a surface of the toner, the graph having a horizontal axis indicating the Feret minimum diameter of primary particles and a vertical axis indicating the frequency, a peak 2 having a peak value in the Feret minimum diameter range of 50 to 1000 nm on the large particle diameter side of the peak value of the peak 1 and being mainly constituted by the inorganic fine particle C is observed.

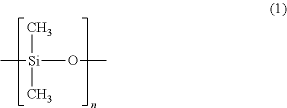

(In formula (1), n represents an integer of 2 or more.)

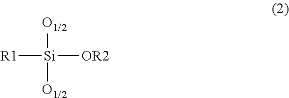

(In formula (2), R1 represents a hydrocarbon group having 1 to 10 carbon atoms, R2 represents a hydrogen atom or a hydrocarbon group having 1 to 10 carbon atoms, and O_{1/2} represents an oxygen atom shared with an adjacent Si atom or Ti atom.)

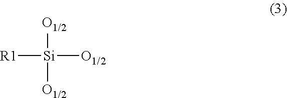

(In formula (3), R1 represents a hydrocarbon group having 1 to 10 carbon atoms, and O_{1/2} represents an oxygen atom shared with an adjacent Si atom or Ti atom.)

The requirements of the present disclosure will now be described in detail.

The toner of the present disclosure contains, as an external additive, metal titanate compound fine particle A.

In time-of-flight secondary ion mass spectrometry (TOF-SIMS) on the metal titanate compound fine particle A serving as a specimen, it is necessary that a fragment ion corresponding to the structure represented by formula (1) below be observed. TOF-SIMS involves analyzing the composition of the specimen surface by analyzing the masses of the secondary ions released from the specimen irradiated with ions. The secondary ions are released from a region several nanometers deep from the specimen surface, and thus it becomes possible to analyze the structure near the surface of the metal titanate compound fine particle A. The fact that a fragment ion represented by formula (1) is observed under TOF-SIMS analysis of the metal titanate compound fine particle A indicates the presence of a polydimethylsiloxane structure on the surfaces of the metal titanate compound fine particle A.

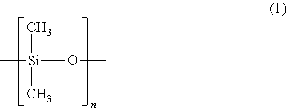

(In formula (1), n represents an integer of 2 or more.)

Furthermore, in a ²⁹Si-NMR spectrum obtained by a solid-state ²⁹Si-NMR CP/MAS method on the metal titanate compound fine particle A serving as a specimen, following (i) to (iv) must be satisfied.
(i) a peak D assigned to a D unit structure is present in the range of −25 ppm to −15 ppm,
(ii) a peak X2 assigned to an X2 unit structure represented by formula (2) below is present in the range of −60 ppm to −50 ppm,
(iii) a peak X3 assigned to an X3 unit structure represented by formula (3) is present in the range of −70 ppm to −60 ppm, and
(iv) S_{D}/(S_{X2}+S_{X3}) is 0.10 to 1.50 where S_{D} represents the area of the peak D, S_{X2} represents the area of the peak X2, and S_{X3} represents the area of the peak X3.

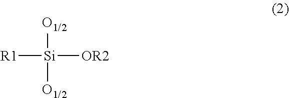

(In formula (2), R1 represents a hydrocarbon group having 1 to 10 carbon atoms, R2 represents a hydrogen atom or a hydrocarbon group having 1 to 10 carbon atoms, and O_{1/2} represents an oxygen atom shared with an adjacent Si atom or Ti atom.)

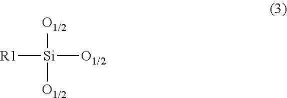

(In formula (3), R1 represents a hydrocarbon group having 1 to 10 carbon atoms, and O_{1/2} represents an oxygen atom shared with an adjacent Si atom or Ti atom.)

In the solid ²⁹Si-NMR CP/MAS method, signals derived from low-mobility Si atoms (immobilized Si atoms) in the measured specimen are observed. Thus, when the metal titanate compound fine particle A are measured by a solid-state ²⁹Si-NMR CP/MAS method, signals derived from the Si atoms immobilized near the surfaces of the metal titanate compound fine particle A are observed. Thus, by analyzing the ²⁹Si-NMR spectrum obtained by the solid-state ²⁹Si-NMR CP/MAS method, quantitative information on the chemical bonding state of the Si atoms near the surfaces of the metal titanate compound fine particle A is obtained.

In general, in solid-state ²⁹Si-NMR, four peaks, that is, those assigned to an M unit (formula (4)), a D unit (formula (5)), a T unit (formula (6)), a Q unit (formula (7)), can be observed with respect to the Si atom in the solid specimen.

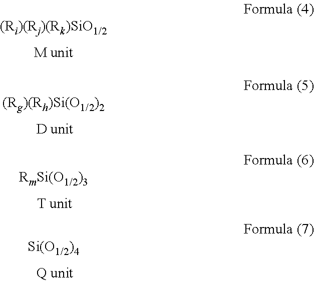

In formulae (4) to (7) above, Rᵢ, Rⱼ, Rₖ, R_{g}, Rₕ, and Rₘ each represent a hydrocarbon group having 1 or more carbon atoms or a halogen atom bonded to silicon.

When the solid specimen has a D unit structure represented by formula (5), a peak (peak D) assigned to the D unit structure is observed in the range of −25 ppm to −15 ppm in an NMR spectrum obtained by solid-state ²⁹Si-NMR. When the solid specimen has a T unit structure represented by formula (6), a peak T assigned to a T unit structure is observed in the range of −70 ppm to −50 ppm in an NMR spectrum obtained by solid-state ²⁹Si-NMR.

For the peak T assigned to the aforementioned T unit structure, the chemical shift value shifts depending on the bonding state of the three oxygen atoms bonded to the Si atom in formula (6). In the case of a structure (hereinafter referred to as X2 unit structure) represented by formula (2) described above in which, of the three oxygen atoms bonded to the Si atom in formula (6), two are bonded to different Si atoms or Ti atoms, a peak (peak X2) is observed in the range of −60 ppm to −50 ppm. Here, the chemical shift value of the peak X2 is observed at −55±3 ppm. In the case of a structure (hereinafter referred to as X3 unit structure) represented by formula (3) described above in which, of the three oxygen atoms bonded to the Si atom in formula (6), all are bonded to different Si atoms or Ti atoms, a peak (peak X3) is observed in the range of −70 ppm to −60 ppm. Here, the chemical shift value of the peak X3 is observed near −65±3 ppm.

In a ²⁹Si-NMR spectrum obtained by a solid-state ²⁹Si-NMR CP/MAS method on the metal titanate compound fine particle A serving as a specimen, the presence of a peak D indicates that a D unit structure is present on the surfaces of the metal titanate compound fine particle A. In a ²⁹Si-NMR spectrum obtained by a solid-state ²⁹Si-NMR CP/MAS method on the metal titanate compound fine particle A serving as a specimen, the presence of a peak X2 and a peak X3 indicates that an X2 unit structure and an X3 unit structure are present on the surfaces of the metal titanate compound fine particle A.

In a ²⁹Si-NMR spectrum obtained by a solid-state ²⁹Si-NMR CP/MAS method on the metal titanate compound fine particle A serving as a specimen, S_{D}/(S_{X2}+S_{X3}) is 0.10 to 1.50 where S_{D} represents the area of the peak D, S_{X2} represents the area of the peak X2, and S_{X3} represents the area of the peak X3. S_{D} means the atomic amount of Si constituting the D unit structure on the surfaces of the metal titanate compound fine particle A. S_{X2} means the atomic amount of Si constituting the X2 unit structure on the surfaces of the metal titanate compound fine particle A. S_{X3} means the atomic amount of Si constituting the X3 unit structure on the surfaces of the metal titanate compound fine particle A.

When the metal titanate compound fine particle A satisfy the aforementioned requirements, the surface treatment on the metal titanate compound fine particle A is less likely to deteriorate and the charge stability can be maintained despite a long-term use in a high-temperature, high-humidity environment. In addition, formation of aggregated particles of the silica fine particle B and the inorganic fine particle C described below can be suppressed. The inventors of the present disclosure presume that the following is the reason why the effects of the present disclosure are obtained by satisfying the aforementioned requirements.

In a ²⁹Si-NMR spectrum obtained by a solid-state ²⁹Si-NMR CP/MAS method on a specimen that is metal titanate compound fine particles surface-treated with only a silane coupling agent, a peak assigned to the X2 unit structure is mainly observed. It is inferred from this result that the silane coupling agent present on the surfaces of the metal titanate compound fine particles is in the following state. Of the three alkoxy groups contained in the silane coupling agent, two react with the hydroxy groups on the metal titanate compound surface, and the Si atoms in the silane coupling agent and the Ti atoms on the surface of the metal titanate compound are chemically bonded to each other via oxygen atoms. Of the three alkoxy groups contained in the silane coupling agent, the remaining one alkoxy group remains unreacted or transforms into and exists as a silanol group.

In a ²⁹Si-NMR spectrum obtained by a solid-state ²⁹Si-NMR CP/MAS method on a specimen that is metal titanate compound fine particles surface-treated with only a silicone oil, a peak assigned to the D unit structure derived from the dimethylsiloxane structure is mainly observed. However, the intensity of the peak assigned to the D unit structure is low. Thus, it is inferred that almost none of the Si atoms in the silicone oil present on the surfaces of the metal titanate compound fine particles are chemically bonded with the Ti atoms on the surfaces of the metal titanate compound fine particles.

As described above, the dimethylsiloxane structure, the D unit structure, the X2 unit structure, and the X3 unit structure are present on the surfaces of the metal titanate compound fine particle A. The D unit structure encompasses a dimethylsiloxane structure. Since the aforementioned effects are obtained during the long-term use in a high-temperature, high-humidity environment, it is considered that the Si atoms contained in the dimethylsiloxane structure, the D unit structure, the X2 unit structure, and the X3 unit structure on the surfaces of the metal titanate compound fine particle A are chemically bonded with Ti atoms, oxygen atoms, etc., present on the surfaces of the metal titanate compound. In addition, by controlling S_{D}/(S_{X2}+S_{X3}) to be in a specified range, strong surface layers can be formed on the surfaces of the metal titanate compound fine particle A, and the charge stability can be maintained. In addition, formation of aggregated particles of the silica fine particle B and the inorganic fine particle C described below can be suppressed.

The toner of the present disclosure further contains, as an external additive, a silica fine particle B and an inorganic fine particle C.

In a graph based on the particle size distribution of silica fine particles obtained by combining SEM image analysis and EDX analysis on the toner surfaces, the graph having a horizontal axis indicating the Feret minimum diameter of primary particles and a vertical axis indicating the frequency, it is necessary that a peak 1 having a peak value in the Feret minimum diameter range of 5 to 100 nm and being mainly constituted by silica fine particle B be observed.

When the aforementioned peak 1 is observed in the particle size distribution of the silica fine particles obtained by combining SEM image analysis and EDX analysis on the toner surface, the charge stability of the toner can be improved. When the peak value of the peak 1 is 5 nm or more, the silica fine particle B are less likely to sink into the toner particle especially during a long-term use in a high-temperature, high-humidity environment, and chargeability and flowability of the toner are maintained. Furthermore, since the silica fine particle B easily break down to primary particles, it becomes possible to sufficiently cover the surface of the toner particle. When the peak value of the peak 1 is 100 nm or less, the silica fine particle B can sufficiently cover the surface of the toner particle, and low-temperature fixability can be maintained even with a high-speed machine specialized in low-temperature fixing. The peak value of the peak 1 can be 10 nm or more and 50 nm or less. Here, the peak value of the peak 1 is the Feret minimum diameter at the maximum frequency in the particle size distribution of the silica particles. The method for measuring the Feret minimum diameter of the silica fine particles and the method for identifying the peak 1 are described in detail below.

Furthermore, in a graph based on the particle size distribution of the external additive obtained by combining SEM image analysis and EDX analysis on the toner surfaces, the graph having a horizontal axis indicating the Feret minimum diameter of primary particles and a vertical axis indicating the frequency, it is necessary that a peak 2 having a peak value in the Feret minimum diameter range of 50 to 1000 nm on the large particle diameter side of the peak value of the peak 1 and being mainly constituted by the inorganic fine particle C be observed.

The fact that the aforementioned peak 2 is observed in the particle size distribution of the external additive obtained by combining the SEM image analysis and EDX analysis on the toner surface indicates that the inorganic fine particle C has a larger particle diameter than the silica fine particle B. When the peak 1 and the peak 2 described above satisfy the aforementioned relationship, the inorganic fine particle C acts as spacer particles, and thus the charge stability and good transferability can be imparted to the toner. Here, the peak value of the peak 2 is the Feret minimum diameter at the maximum frequency in the particle size distribution of the external additive. The method for measuring the Feret minimum diameter of the external additive and the method for identifying the peak 2 are described in detail below.

When the peak value of the peak 2 is 50 nm or more, the inorganic fine particle C acts as spacer particles, and thus good flowability can be imparted to the toner. In addition, the inorganic fine particle C acts as abrasive particles, polish the fused toner adhering to the developer bearing member and the photosensitive member, and can suppress image defects caused by the fused toner over a long period of time. When the peak value of the peak 2 is 1000 nm or less, the properties of the inorganic fine particle C to stick to the toner particle can be maintained, and flowability and transferability of the toner can be maintained. The peak value of the peak 2 can be in the range of 70 nm or more and 300 nm or less.

The inorganic fine particle C is a fine particle selected from the group consisting of a silica fine particle C, an alumina fine particle C, and a titania fine particle C. Since the silica fine particle C, the alumina fine particle C, and the titania fine particle C have appropriate hardness, the fused toner adhering to the developer bearing member and the photosensitive member can be polished, and image defects caused by the fused toner can be suppressed.

For the reasons described above, when the metal titanate compound fine particle A, the silica fine particle B, and the inorganic fine particle C are contained as the external additive of the toner, the charge stability of the toner can be maintained despite long-term use in a high-temperature, high-humidity environment. Furthermore, formation of aggregated particles caused by metal titanate compound fine particles can be suppressed, and development regulation failure caused by the aggregated particles and the image defects caused thereby can be suppressed.

In a graph based on the particle size distribution of metal titanate compound fine particles obtained by combining SEM image analysis and EDX analysis on the toner surfaces, the graph having a horizontal axis indicating the Feret minimum diameter of primary particles and a vertical axis indicating the frequency, a peak 3 having a peak value in the Feret minimum diameter range of 0.5 to 1000 nm and being mainly constituted by the metal titanate compound fine particle A can be observed, and the peak value D_{A} (nm) of the peak 3 can be 5 to 50 nm. When D_{A} is 5 to 50 nm, the function of adjusting the charge amount of the toner is enhanced. D_{A} can be 15 to 40 nm. Here, the peak value D_{A} is the Feret minimum diameter at the maximum frequency in the particle size distribution of the metal titanate compound fine particles.

In addition, D_{A}, a peak value D_{B} (nm) of the peak 1, and a peak value D_{C} (nm) of the peak 2 can satisfy the following relationships.

$$0.10 \leq {D}_{A} / {D}_{B} \leq 10 \text{.00}$$

$$0.01 \leq {D}_{B} / {D}_{C} \leq 0 \text{.80}$$

$$0.01 \leq {D}_{A} / {D}_{C} \leq 1.$$

D_{A}/D_{B} means the ratio of the Feret minimum diameter of the primary particles of the metal titanate compound fine particle A to the Feret minimum diameter of the primary particles of the silica fine particle B. D_{B}/D_{C} means the ratio of the Feret minimum diameter of the primary particles of the silica fine particle B to the Feret minimum diameter of the primary particles of the inorganic fine particle C.

D_{A}/D_{C} means the ratio of the Feret minimum diameter of the primary particles of the metal titanate compound fine particle A to the Feret minimum diameter of the primary particles of the inorganic fine particle C. When D_{A}, D_{B}, and D_{C} satisfy the aforementioned relationships, the charge stability and the good transferability are maintained in the long-term use in a high-temperature, high-humidity environment, and the development regulation failure caused by aggregated particles and image defects caused thereby can be suppressed. D_{A}/D_{B} can be 0.50 or more and 3.50 or less. D_{B}/D_{C} can be 0.10 or more and 0.43 or less. D_{A}/D_{C} can be 0.05 or more and 1.00 or less. D_{A}, D_{B}, and D_{C} may satisfy the relationship D_{B}<D_{A}<D_{C}, since the charge stability and the good transferability are maintained in the long-term use in a high-temperature, high-humidity environment, and the development regulation failure caused by aggregated particles and image defects caused thereby can be suppressed.

The a coverage ratio (area %) S_{A} of the toner particle by the metal titanate compound fine particle A, the a coverage ratio (area %) S_{B} of the toner particle by the silica fine particle B, and the a coverage ratio (area %) S_{C} of the toner particle by the inorganic fine particle C may satisfy the following relationships.

$$0.01 \leq {S}_{A} / {S}_{B} \leq 0 \text{.30}$$

$$1. \leq {S}_{B} / {S}_{C} \leq 80.$$

$$0.3 \leq {S}_{A} / {S}_{C} \leq 22.00$$

When S_{A}, S_{B}, and S_{C} satisfy the aforementioned relationships, the charge stability and the good transferability are maintained in the long-term use in a high-temperature, high-humidity environment, and the development regulation failure caused by aggregated particles and image defects caused thereby can be suppressed. S_{A}/S_{B} can be 0.04 or more and 0.21 or less. S_{B}/S_{C} can be 5.00 or more and 50.00 or less. S_{A}/S_{C} can be 0.70 or more and 12.60 or less. The total of S_{A}, S_{B}, and S_{C} can be 10 area % or more and 75 area % or less from the viewpoints of the endurance and fixability of the toner. The method for measuring the coverage ratio of the toner particle by each type of fine particles is described in detail below.

### External Additive

The toner of the present disclosure contains, as an external additive, the metal titanate compound fine particle A, the silica fine particle B, and the inorganic fine particle C. If necessary, other external additives may be added.

### Metal Titanate Compound Fine Particle A

Barium titanate fine particles, strontium titanate fine particles, calcium titanate fine particles, etc., can be used as the metal titanate compound fine particle A of the present disclosure. The amount of the metal titanate compound fine particle A contained in the toner relative to 100 parts by mass of the toner particle can be 0.1 parts by mass or more and 5.0 parts by mass or less or can be 0.3 parts by mass or more and 4.0 parts by mass or less. When the amount of the metal titanate compound fine particle A contained is within this range, the function of adjusting the charge amount of the toner is enhanced.

The metal titanate compound fine particle A can be strontium titanate fine particles. The method for producing the strontium titanate fine particles is not particularly limited and may be, for example, a wet method or a sintering method or can be a wet method since the surface treatment efficiency is high.

The strontium titanate fine particles may contain a dopant. Examples of the dopant for the strontium titanate fine particles include, but are not limited to, lanthanoids, silica, aluminum, magnesium, calcium, barium, vanadium, chromium, manganese, iron, cobalt, nickel, copper, zinc, gallium, niobium, molybdenum, ruthenium, palladium, indium, antimony, tantalum, tungsten, rhenium, iridium, platinum, bismuth, yttrium, zirconium, niobium, silver, and tin. The lanthanoids can be lanthanum and cerium. Among these, lanthanum and silica may be used since the size thereof allows easy entry into the crystal structure.

The strontium titanate fine particles can be obtained by, for example, a normal pressure heat reaction method. Here, a mineral acid-peptized product of a hydrolysis product of a titanium compound is used as the titanium oxide source, and a water-soluble acidic metal compound is used as the metal source of strontium. The particles can be produced by causing a reaction of a mixture thereof while adding an alkaline aqueous solution thereto at 60° C. or higher and then acid-treating the resulting product.

### Normal Pressure Heat Reaction Method

A mineral acid-peptized product of a hydrolysis product of a titanium compound is used as the titanium oxide source. For example, a peptized product of metatitanic acid obtained by adjusting the pH of metatitanic acid, which has been obtained by a sulfuric acid method and has a SO₃ content of 1.0 mass % or less or 0.5 mass % or less, to 0.8 to 1.5 by using hydrochloric acid can be used. Metatitanic acid having a SO₃ content exceeding 1.0 mass % may be avoided since peptization does not proceed.

Examples of the metal source other than the aforementioned titanium include nitrates and hydrochlorides of metals. Examples of the nitrates include strontium nitrate. Examples of the hydrochlorides include strontium chloride. In particular, when a nitrate or hydrochloride of strontium is used in the production, the strontium titanate fine particles obtained assumes a perovskite crystal structure, and thus the environmental stability of the charges further improves.

A caustic alkali can be used as the alkaline aqueous solution, and, in particular, an aqueous sodium hydroxide solution can be used.

In the aforementioned production method, the factors that would affect the particle diameter of the obtained strontium titanate fine particles are, for example, the ratio of mixing the titanium oxide source and the strontium source in the reaction, the titanium oxide source concentration in the initial stage of the reaction, and the temperature and rate of adding the alkaline aqueous solution, and these factors can be adjusted as appropriate in order to obtain the fine particles of the target particle diameter and particle size distribution. It should be noted that mixing of carbon dioxide is to be avoided to prevent generation of carbonates during the reaction process, such as carrying out the direction in a nitrogen gas atmosphere.

In the aforementioned production method, the factors that would affect the particle size distribution of the obtained strontium titanate fine particles are, for example, the pH during peptization of metatitanic acid with hydrochloric acid, the titanium oxide source concentration in the initial stage of the reaction, and the temperature and rate of adding the alkaline aqueous solution and the stirring conditions. In particular, terminating the reaction by rapidly cooling the system by, for example, putting the mixture in ice water after addition of the alkaline aqueous solution can forcibly terminate the reaction before the crystal growth reaches saturation, and the particle diameter is likely to be broad. Moreover, the particle diameter distribution tends to be broad when the state of the reaction system is made inhomogeneous, such as when the stirring rate is lowered or the stirring method is changed.

The mixing ratio of the titanium oxide source and the strontium oxide source for the reaction in terms of MxO/TiO₂ molar ratio (where MxO is an oxide of M representing all metals other than titanium, x is 1 when M is an alkaline earth metal and is 2 when M is an alkali metal) can be 0.90 to 1.40 or can be 1.05 to 1.20. When the MO/TiO₂ molar ratio is 1 or less, not only metal titanates but also unreacted titanium oxide tend to remain in the reaction product. Whereas metal sources other than titanium relatively have high solubility in water, the titanium oxide source has low solubility in water, and thus when the MxO/TiO₂ molar ratio is 1 or less, not only metal titanates but also unreacted titanium oxide tend to remain in the reaction product. The appropriate concentration of the titanium oxide source in the initial stage of reaction in terms of TiO₂ is 0.05 to 1.30 mol/L or 0.08 to 1.00 mol/L.

The appropriate temperature during addition of the alkaline aqueous solution is 60° C. to 100° C. from the practical viewpoint since a pressure reactor such as an autoclave is necessary when the temperature is 100° C. or higher. Furthermore, the lower the alkaline aqueous solution addition rate, the larger the particle diameter of the obtained strontium titanate fine particles, and the faster the addition rate, the smaller the particle diameter of the obtained strontium titanate fine particles. The alkaline aqueous solution addition rate is appropriately 0.001 to 1.2 eq/h or 0.002 to 1.1 eq/h relative to the charge raw materials, and can be adjusted as appropriate according to the particle diameter to be obtained.

### Acid Treatment

In the aforementioned production method, the strontium titanate fine particles obtained by a normal pressure heat reaction may be further subjected to an acid treatment. When the mixing ratio of the titanium oxide source and the strontium source in terms of the MxO/TiO₂ ratio exceeds 1.0 during the process of synthesizing strontium titanate fine particles by performing a normal pressure heat reaction, the unreacted strontium source remaining after the termination of the reaction reacts with carbon dioxide gas in the air, as a result of which impurities such as metal carbonates are generated. In addition, when impurities such as metal carbonates remain on the surface and when an organic surface treatment is performed to impart hydrophobicity, the surface cannot be sufficiently covered with the organic surface treating agent. Thus, after the alkaline aqueous solution is added, an acid treatment may be performed to remove unreacted metal sources.

In the acid treatment, the pH can be adjusted to 2.5 to 7.0 or 4.5 to 6.0 by using hydrochloric acid. Examples of the acid that can be used instead of hydrochloric acid include nitric acid and acetic acid. The use of sulfuric acid generates metal sulfates that have low solubility in water, and thus may be avoided.

The toner particle and the metal titanate compound fine particle A can be mixed by using a known mixer such as Henschel mixer (produced by Mitsui Mining Corporation), Mechano Hybrid (produced by NIPPON COKE & ENGINEERING. CO., LTD.), Super Mixer (produced by KAWATA MFG. CO., LTD.), and Nobilta (produced by Hosokawa Micron Corporation), and the apparatus used is not particularly limited. Examples of the mixing conditions include the treatment amount, the rotation speed of the stirring shaft, the stirring time, the shape of the stirring blade, and the temperature inside the chamber.

The metal titanate compound fine particle A of the present disclosure may be surface-treated from the viewpoint of hydrophobicity and chargeability.

A silane compound may be used for the surface treatment of the metal titanate compound fine particle A. Examples of the silane compound include, but are not limited to, alkoxysilanes such as methoxysilane, ethoxysilane, and propoxysilane, halosilanes such as chlorosilane, bromosilane, and iodosilane, hydrosilanes, alkylsilanes, arylsilanes, vinylsilanes, acrylic silanes, epoxysilanes, silyl compounds, siloxanes, silylureas, silylacetamides, and silane compounds simultaneously having different substituents contained in these silane compounds.

Specific examples thereof include trimethylsilane, trimethylchlorosilane, trimethylethoxysilane, dimethyldichlorosilane, methyltrichlorosilane, trialkoxyalkylsilane, allyldimethylchlorosilane, α-chloroethyltrichlorosilane, β-chloroethyltrichlorosilane, chloromethyldimethylchlorosilane, dimethyldiethoxysilane, dimethyldimethoxysilane, and hexamethyldisiloxane.

In particular, alkyltrialkoxysilanes may be used from the viewpoint of hydrophobization and chargeability. For example, methyltriethoxysilane, ethyltrimethoxysilane, n-propyltrimethoxysilane, isobutyltrimethoxysilane, n-hexyltrimethoxysilane, and n-octyltriethoxysilane may be used. In particular, the number of carbon atoms in the alkyl group can be 3 to 6, and isobutyltrimethoxysilane may be used. An alkyltrialkoxysilane having an alkyl group having 3 to 6 carbon atoms can be used due to good reactivity to the surfaces of the metal titanate compound fine particles and good reactivity to the silicone oil described below.

The treatment method with a silane coupling agent is not particularly limited, and examples thereof include a method that involves spraying a coupling agent onto the surfaces of the metal titanate compound fine particle bases, and a method that involves mixing a vaporized coupling agent and metal titanate compound fine particle bases and heat-treating the resulting mixture. Here, water, an amine, and any other catalyst may be used. The surface modification caused by the coupling agent can be performed in an inert gas atmosphere such as nitrogen. Alternatively, a method that involves mixing a coupling agent, metal titanate compound fine particle bases, and a solvent and then heating and drying the resulting mixture may also be employed. Here, either the coupling agent or the metal titanate compound fine particle bases may be dispersed in a solvent in advance, or all components may be mixed simultaneously.

When the primary particle diameter of the metal titanate compound fine particle bases is 0.02 to 0.3 μm, the bases can be coated with a hydrophobizing agent in an aqueous system since the dispersibility is further improved. The method in which the treatment is conducted in the aqueous system is not particularly limited, and, for example, a method that involves allowing a silane coupling agent to adsorb onto a metal titanate compound fine particle base slurry in water can be employed.

A silicone oil may be used for the surface treatment of the metal titanate compound fine particle A.

The silicone oil is not particularly limited, and examples thereof include a dimethyl silicone oil, an alkyl-modified silicone oil, an α-methylstyrene-modified silicone oil, a chlorophenyl silicone oil, and a fluorine-modified silicone oil. These silicone oils may have a viscosity of 1.0×10⁻⁷ m²/s or more and 0.1 m²/s or less at a temperature of 25° C.

A known method may be used as a method for the silicone oil treatment. For example, a powder of metal titanate compound fine particles and a silicone oil are mixed by using a mixer. Examples this method include spraying a silicone oil onto the powder of metal titanate compound fine particles by using a sprayer, and dissolving a silicone oil in a solvent and then performing mixing. The treatment method is not limited to this.

When the primary particle diameter of the metal titanate compound fine particle bases is 0.02 to 0.3 μm, the bases can be coated with a hydrophobizing agent in an aqueous system since the dispersibility is further improved. The method in which the treatment is conducted in the aqueous system is not particularly limited, and, for example, a method that involves allowing a silicone oil, which has been emulsified with an emulsifying agent, to adsorb onto a metal titanate compound fine particle base slurry can be employed.

The surface treatment of the titanate compound fine particle A can involve a surface treatment that uses a silane coupling agent and a silicone oil or can involve a surface treatment that involves performing a surface treatment with a silane coupling agent and further with a silicone oil. When a treatment with a silicone oil follows a treatment with a silane coupling agent, the silicone oil readily reacts with alkoxy groups or silanol groups derived from the silane coupling agent, and it becomes easy to control the amounts of the dimethylsiloxane structure, the D unit structure, the X2 unit structure, the X3 unit structure, and hydroxy groups on the surfaces of the metal titanate compound fine particle A. In particular, when the silane coupling agent is an alkyltrialkoxysilane having an alkyl group having 3 to 6 carbon atoms, the amount of the hydroxy groups on the surfaces of the metal titanate compound fine particle A can be further controlled, and an effect of enhancing the charge stability is obtained. The reason why these effects are obtained inferred by the inventors of the present disclosure is as follows.

As described above, when the metal titanate compound fine particle bases are surface-treated with a silane coupling agent, the state of the silane coupling agent present on the surfaces of the metal titanate compound fine particles is presumably as follows. Of the three alkoxy groups contained in the silane coupling agent, two react with the hydroxy groups on the metal titanate compound surface, and the Si atoms in the silane coupling agent and the Ti atoms on the surface of the metal titanate compound are chemically bonded to each other via oxygen atoms. Of the three alkoxy groups contained in the silane coupling agent, the remaining one alkoxy group remains unreacted or exists as a silanol group.

When the metal titanate compound fine particle bases surface-treated with a silane coupling agent are further surface-treated with a silicone oil, the dimethylsiloxane structure contained in the silicone oil and the unreacted alkoxy groups or silanol groups contained in the silane coupling agent undergo polyaddition reaction, and a X3 unit structure is formed. By controlling the reaction state of the silane coupling agent and the silicone oil, the amounts of the dimethylsiloxane structure, the D unit structure, the X2 unit structure, the X3 unit structure, and hydroxy groups on the surfaces of the metal titanate compound fine particle A can be controlled. As a result, it becomes possible to form a strong surface treatment layer on the surfaces of the metal titanate compound fine particle A, and the charge stability can be maintained. In addition, since the dimethylsiloxane structure is immobilized by chemical bonding near the surfaces of the metal titanate compound fine particle A, slidability can be imparted to the metal titanate compound fine particle A. As a result, formation of aggregated particles of the silica fine particle B and the inorganic fine particle C can be suppressed, and thus the charge stability can be maintained and occurrence of the image defects can be suppressed despite the long-term use in a high-temperature, high-humidity environment.

Regarding the titanate compound fine particle A surface-treated with a silane coupling agent and a silicone oil, S_{D} means the amount of Si atoms constituting the dimethylsiloxane structure on the surfaces of the metal titanate compound fine particle A. S_{X2} means the amount of Si atoms constituting the X2 unit structure derived from the silane coupling agent on the surfaces of the metal titanate compound fine particle A. S_{X3} means the amount of Si atoms constituting the X3 unit structure derived from the silane coupling agent on the surfaces of the metal titanate compound fine particle A.

Regarding the titanate compound fine particle A surface-treated with a silane coupling agent and a silicone oil, S_{D}/(S_{X2}+S_{X3}) indicates the ratio of the amount of Si atoms constituting the silicone oil to the amount of Si atoms derived from the silane coupling agent near the surfaces of the metal titanate compound fine particle A. When S_{D}/(S_{X2}+S_{X3}) is 0.10 or more and 1.50 or less, an appropriate amount of hydroxy groups remain on the surfaces of the metal titanate compound fine particles, and a strong surface treatment layer can be formed. S_{D}/(S_{X2}+S_{X3}) can be 0.30 or more and 1.00 or less.

In addition, S_{X2} and S_{X3} can satisfy the relationship S_{X2}<S_{X3}. When S_{X2} and S_{X3} satisfy the aforementioned relationships, the charge stability can be more easily obtained. Regarding the titanate compound fine particle A surface-treated with a silane coupling agent and a silicone oil, the fact that the relationship S_{X2}<S_{X3} is satisfied indicates that at least a half of the T unit structures derived from the silane coupling agent present on the surfaces of the metal titanate compound fine particle A have undergone the polyaddition reaction with the dimethylsiloxane structures derived from the silicone oil. When S_{X2} and S_{X3} satisfy the aforementioned relationship, the amount of silanol groups (amount of hydroxy groups) derived from the silane coupling agent can be decreased, and the charge stability can be more easily obtained.

Regarding the silane coupling agent used in surface-treating the metal titanate compound fine particle bases, S_{X2} can be decreased by extending the length of the alkyl chains bonded to Si atoms, and S_{X2} can be increased by shortening the length of the alkyl chains bonded to Si atoms. Furthermore, S_{X2} can be decreased by surface-treating the metal titanate compound fine particle bases with a treating agent such as a silicone oil after surface-treating the metal titanate compound fine particle bases with a silane coupling agent.

### Amount of Carbon Atoms in Metal Titanate Compound Fine Particle A

The amount of the surface treatment with a silane coupling agent or a silicone oil relative to the metal titanate compound fine particle A can be confirmed by measuring the amount of carbon atoms contained in the metal titanate compound fine particle A (this amount is hereinafter referred to as the C amount). The C amount (mass %) in the metal titanate compound fine particle A can be 0.5 to 10.0 mass %.

When the C amount is 10.0 mass % or less, disintegratability of the metal titanate compound fine particle A is sufficient, formation of aggregated particles of the silica fine particle B and the inorganic fine particle C can be suppressed, and good flowability can be imparted to the toner. When the C amount is 0.5 mass % or more, a sufficient amount of the surface treating agent is present on the surfaces of the metal titanate compound fine particle A, and degradation of the chargeability can be suppressed even in a high-temperature, high-humidity environment. In addition, by adjusting the C amount to be within the aforementioned range, the powder resistivity of the metal titanate compound fine particle A can also be controlled. By using the metal titanate compound fine particle A, the silica fine particle B, and the inorganic fine particle C in combination as an external additive, the charge stability of the toner can be improved.

The amount (parts by mass) of the surface treatment with a silane coupling agent or silicone oil relative to the metal titanate compound fine particle A can be 1.0 to 25.0 parts by mass or can be 1.0 to 15.0 parts by mass per 100 parts by mass of the metal titanate compound fine particle bases. Silane coupling agents or silicone oils can be used alone or in combination.

### Silica Fine Particle B

Silica fine particles obtained by a know method may be used as the silica fine particle B without any limitation. Examples thereof include sol-gel silica fine particles prepared by a sol-gel method, water-based colloidal silica fine particles, alcoholic silica fine particles, fumed silica fine particles obtained by a gas phase method, and fused silica fine particles.

In particular, fumed silica is excellent in imparting flowability to the toner, and can be used as silica fine particle bases used in an external additive for electrophotographic toners.

Surface-treated silica fine particle bases can be used as the silica fine particle B. An example of the surface treatment method is a method that involves performing a chemical treatment with a silicon compound that reacts with or physically adsorbs to the silica fine particle bases. The specific surface area of the silica fine particle bases measured by a BET method by nitrogen adsorption can be 30 m²/g or more and 300 m²/g or less.

The amount of the silica fine particle B contained in the toner relative to 100 parts by mass of the toner particle can be 0.1 parts by mass or more and 10.0 parts by mass or less or can be 0.3 parts by mass or more and 4.0 parts by mass or less. When the amount of the silica fine particle B contained is in this range, the function of adjusting the charge amount of the toner is enhanced.

### Inorganic Fine Particle C

The inorganic fine particle C is a fine particle selected from the group consisting of a silica fine particle C, an alumina fine particle C, and a titania fine particle C. The inorganic fine particle C may have a Vickers hardness of 5.0 GPa or more and 18.0 GPa or less.

Examples of the silica fine particle C include sol-gel silica fine particles prepared by a sol-gel method, water-based colloidal silica fine particles, alcoholic silica fine particles, fumed silica fine particles obtained by a gas phase method, and fused silica fine particles.

The amount of the inorganic fine particle C contained in the toner relative to 100 parts by mass of the toner particle can be 0.05 parts by mass or more and 3.00 parts by mass or less or can be 0.10 parts by mass or more and 1.00 parts by mass or less.

### Other External Additives

Specific examples of the external additives include inorganic fine particles such as hydrotalcite particles, and resin fine particles such as vinyl resins, polyester resins, and silicone resins. These external additives can be added by applying a shear force in a dry state, for example.

Hydrotalcite particles may be, for example, common hydrotalcite particles represented by structural formula (A) below.

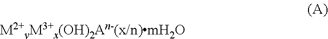

Here, 0<x≤0.5, y=1−x, and m≥0.

In addition, M²⁺ and M³⁺ respectively represent a divalent metal ion and a trivalent metal ion.

M²⁺ can be at least one divalent metal ion selected from the group consisting of Mg, Zn, Ca, Ba, Ni, Sr, Cu, and Fe. M³⁺ can be at least one trivalent metal ion selected from the group consisting of Al, B, Ga, Fe, Co, and In.

Aⁿ⁻ is an n-valent anion, for example, CO₃²⁻, OH⁻, Cl⁻, I⁻, F⁻, Br⁻, SO₄²⁻, HCO₃⁻, CH₃COO⁻, or NO₃⁻, and may be one anion or multiple anions.

Hydrotalcite particles can contain at least Al as M³⁺.

In addition, at least Mg can be contained as M²⁺. Hydrotalcite particles can contain Al and Mg. Hydrotalcite particles may be a solid solution containing multiple elements. In addition, a trace amount of a monovalent metal may be contained.

### Binder Resin

The toner particle contains a binder resin. The amount of the binder resin contained can be 50 mass % or more of the total amount of the resin components in the toner particle.

The binder resin is not particularly limited, and examples thereof include a styrene acrylic resin, an epoxy resin, a polyester resin, a polyurethane resin, a polyamide resin, a cellulose resin, a polyether resin, and mixed resins and composite resins thereof. The binder resin can contain at least one selected from the group consisting of a styrene acrylic resin and a polyester resin. The binder resin may contain a styrene acrylic resin.

Examples of the styrene acrylic resin include homopolymers prepared from the following polymerizable monomers, copolymers obtained by combining two or more of these monomers, and mixtures of the monomers. Styrenic monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; (meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, and 2-benzoyloxyethyl (meth)acrylate, (meth)acrylonitrile, 2-hydroxyethyl (meth)acrylate, (meth)acrylic acid, and maleic acid; vinyl ether monomers such as vinyl methyl ether and vinyl isobutyl ether; vinyl ketone monomers such as vinyl methyl ketone, vinyl ethyl ketone, and vinyl isopropenyl ketone; and polyolefins such as ethylene, propylene, and butadiene.

For a styrene acrylic resin, a polyfunctional polymerizable monomer can be used as necessary. Examples of the polyfunctional polymerizable monomer include diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolmethane tetra(meth)acrylate, divinylbenzene, divinylnaphthalene, and divinyl ether.

The toner particle can have a polyester resin D on the surfaces thereof from the viewpoint of the environmental stability.

The polyester resin D can have, as a monomer unit constituting a polymer chain, at least one selected from the group consisting of a monomer unit corresponding to an alcohol having an alicyclic structure and a monomer unit corresponding to a carboxylic acid having an alicyclic structure. “Monomer unit” refers to a structure in the polymer and is formed by the reaction of a monomer.

The polyester resin D is, for example, a polycondensate of an acid component and an alcohol component. A polymer chain is formed as a result of the polycondensation of these components. The polymer chain contains a structure in which a monomer unit obtained from an acid component and a monomer unit obtained from an alcohol component are bonded via an ester bond. For example, these monomer units form repeating units. At least one of the monomer unit obtained from the acid component and the monomer unit obtained from the alcohol component in the polyester resin D can have an alicyclic structure. Here, the alicyclic structure can be incorporated in the main chain of the polyester resin.

The polyester resin D may have, as this polymer chain, only a linear main chain or a branched chain with a main chain and a side chain. In the case of the branched chain, the alicyclic structure can be incorporated as a structural unit of the main chain and/or the side chain.

The weight average molecular weight (Mw) of the polyester resin D is, for example, 5,000 to 50,000 and may be 8,000 to 20,000.

Here, “alicyclic compound” refers to a compound that contains an aromaticity-free cyclic structure. According to the classification based on the constituent elements, the alicyclic structure may be classified into an alicyclic hydrocarbon structure in which the aromaticity-free cyclic structure is solely composed of carbon and hydrogen and an alicyclic heterocyclic structure in which the aromaticity-free cyclic structure contains carbon, hydrogen, and other elements, and any of these alicyclic structures can be used.

Examples of the monomer as the acid component (acid monomer) and the monomer as the alcohol component (alcohol monomer) containing the alicyclic hydrocarbon group structure include various types of monomers described below.

Examples of the acid monomer include 1,4-cyclohexanedicarboxylic acid, 1,3-cyclohexanedicarboxylic acid, 1,2-cyclohexanedicarboxylic acid, 4-methyl-1,2-cyclohexanedicarboxylic acid, cis-4-cyclohexene-1,2-dicarboxylic acid, cis-1-cyclohexene-1,2-dicarboxylic acid, norbornanedicarboxylic acid, norbornenedicarboxylic acid, 1,3-adamantanedicarboxylic acid, 1,3,5-cyclohexanetricarboxylic acid, 1,2,4-cyclohexanetricarboxylic acid, 1,2,4,5-cyclohexanetetracarboxylic acid, 1,2,3,4,5,6-cyclohexanehexacarboxylic acid, and methylcyclohexenetricarboxylic acid.

Examples of the alcohol monomer include 1,4-cyclohexanedimethanol, hydrogenated bisphenol A, 1,4-cyclohexanediol, 1,2-cyclohexanediol, 1,3-cyclohexanediol, 4-(2-hydroxyethyl)cyclohexanol, 4-(hydroxymethyl)cyclohexanol, 4,4′-bicyclohexanol, and 1,3-adamantanediol. Examples of the monomer having an alicyclic heterocyclic structure include alcohol monomers such as isosorbide and spiroglycol.

In particular, isosorbide may be used as the alcohol monomer so that the main chain and/or the side chain of the polyester resin has the isosorbide structure as the constituting unit of the polymer chain. Due to the presence of the isosorbide structure, the toner surface layers become highly polar, and electrostatically appropriate attraction easily occurs with hydrotalcite. As a result, condensing of hydrotalcite can be suppressed. In other words, the polyester resin D may have a monomer unit corresponding to isosorbide.

The monomer unit corresponding to isosorbide is represented by formula (H) below.

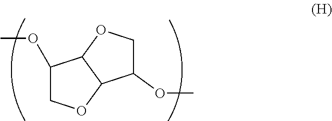

The polyester resin D can be prepared by a method that involves dehydration condensation of, in addition to the alcohol or carboxylic acid having an alicyclic structure, a dibasic acid and a derivative thereof (carboxylic acid halides, esters, and acid anhydrides) and a dihydric alcohol, and, if necessary, a tri- or higher functional polybasic acid and a derivative thereof (carboxylic acid halides, esters, and acid anhydrides), a monobasic acid, a tri- or higher hydric alcohol, a monohydric alcohol, etc., described below.

Examples of the dibasic acid include aliphatic dibasic acids such as maleic acid, fumaric acid, itaconic acid, oxalic acid, malonic acid, succinic acid, dodecylsuccinic acid, dodecenylsuccinic acid, adipic acid, azelaic acid, sebacic acid, and decane-1,10-dicarboxylic acid; and aromatic dibasic acids such as phthalic acid, tetrahydrophthalic acid, hexahydrophthalic acid, tetrabromophthalic acid, tetrachlorophthalic acid, HET acid, hymic acid, isophthalic acid, terephthalic acid, and 2,6-naphthalenedicarboxylic acid. Examples of the derivative of the dibasic acid include the aforementioned aliphatic dibasic acids, and carboxylic acid halides, esterified products, and acid anhydrides of aromatic dibasic acids.

Examples of the dihydric alcohol include aliphatic diols such as ethylene glycol, 1,2-propylene glycol, 1,4-butanediol, 1,5-pentanediol, 1,6-hexanediol, diethylene glycol, dipropylene glycol, triethylene glycol, and neopentyl glycol; bisphenols such as bisphenol A and bisphenol F; alkylene oxide adducts of bisphenol A such as ethylene oxide adducts of bisphenol A and propylene oxide adducts of bisphenol A; and aralkylene glycols such as xylylene glycol.

Examples of the tri- or higher functional polybasic acid and the anhydride thereof include trimellitic acid, trimellitic anhydride, 1,3,5-cyclohexanetricarboxylic acid, 1,2,4-cyclohexanetricarboxylic acid, 1,2,4,5-cyclohexanetetracarboxylic acid, 1,2,3,4,5,6-cyclohexanehexacarboxylic acid, methylcyclohexene tricarboxylic acid, methylcyclohexene tricarboxylic anhydride, pyromellitic acid, and pyromellitic anhydride.

Other examples include polyolefins such as ethylene, propylene, and butadiene.

### Charge Control Agent and Charge Control Resin

The toner particle may contain a charge control agent and/or a charge control resin. A known charge control agent may be used as the charge control agent, and, in particular, a charge control agent that has a high triboelectric charging speed and is capable of stably maintaining a particular triboelectric charge quantity can be used as the charge control agent. Furthermore, when a toner particle is produced by a suspension polymerization method, a charge control agent that has a low polymerization inhibiting property and substantially free of matters soluble in the aqueous medium can be used.

Examples of the matters that control the toner to have negative chargeability include metal monoazo metal compounds, acetylacetone metal compounds, aromatic oxycarboxylic acids, aromatic dicarboxylic acids, metal compounds based on oxycarboxylic acids and dicarboxylic acid, aromatic oxycarboxylic acids, aromatic mono- and polycarboxylic acids and metal salts thereof, anhydrides, esters, phenol derivatives such as bisphenol, urea derivatives, metal-containing salicylic acid compounds, metal-containing naphthoic acid compounds, and charge control resins.

The toner particle may have, on a surface thereof, a charge control resin that has a structure represented by formula (8) below as an ionic functional group. The charge control resin can be a vinyl resin or a styrene resin.

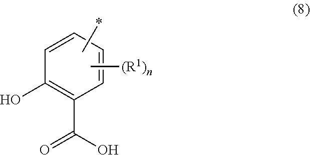

In formula (8), R¹ each independently represent an alkyl group having 1 to 18 carbon atoms or an alkoxy group having 1 to 18 carbon atoms, n represents an integer of 0 to 3, and * is the bonding site with the polymer. Examples of the alkyl group represented by R¹ include a methyl group, an ethyl group, a propyl group, an isopropyl group, a butyl group, an isobutyl group, a s-butyl group, and a t-butyl group, and examples of the alkoxy group include a methoxy group, an ethoxy group, and a propoxy group.

When the charge control resin is contained, the charge rising property and the charge stability are improved, and so is the environmental stability. The amount of the charge control resin contained in the toner particle relative to 100 parts by mass of the binder resin can be 0.1 to 3.0 parts by mass or can be 0.2 to 1.0 parts.

The resin having an ionic functional group may be any resin that has an ionic functional group represented by formula (8). For example, polymerization products of vinyl salicylic acid and 1-vinyl phthalate can be used. The charge control resin can be a vinyl resin (in particular, a styrene resin) having a structure corresponding to a monomer represented by formula (9) below.

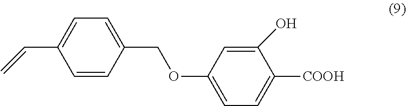 [SMILES: C=Cc1ccc(COc2ccc(C(=O)O)c(O)c2)cc1]

The main chain structure of the polymer is not particularly limited. Examples thereof include a vinyl polymer, a polyester polymer, a polyamide polymer, a polyurethane polymer, and a polyether polymer. A hybrid polymer in which two or more of these polymers are combined is another example. Considering the adhesion to the toner base particles, a vinyl polymer can be used.

Examples of the matters that control the toner to be positively chargeable include nigrosine and fatty acid metal salts-modified products thereof; quaternary ammonium salts such as tributylbenzylammonium-1-hydroxy-4-naphthosulfonate, tetrabutylammonium tetrafluoroborate, and analogues thereof; lake pigments such as onium salts such as phosphonium salts; triphenylmethane dyes and lake pigments thereof (examples of the laking agent include phosphotungstic acid, phosphomolybdic acid, phosphotungstomolybdic acid, tannic acid, lauric acid, gallic acid, and ferricyanide compounds); metal salts of higher fatty acids; and charge control resins.

The toner particle may contain a charge control resin that controls the toner to be positively chargeable.

In particular, a charge control resin containing a quaternary ammonium salt or a quaternary ammonium salt group can be contained. By containing this resin, hydrotalcite appropriately sticks to the toner particle, and the charge rising property and the charge stability are improved.

### Release Agent

The toner particle contains a release agent. A known wax can be used as the release agent.

Specific examples thereof include petroleum wax such as paraffin wax, microcrystalline wax, and petrolactam, and derivatives thereof, montan wax and derivatives thereof, Fischer-Tropsch hydrocarbon wax and derivatives thereof, polyolefin wax such as polyethylene and polypropylene and derivatives thereof, natural waxes such as carnauba wax and candelilla wax and derivatives thereof, and ester wax. Here, derivatives include oxides, block copolymers with vinyl monomers, and graft-modified compounds.

Examples of the ester wax include monofunctional ester wax, difunctional ester wax, and polyfunctional ester wax such as tetra-functional or penta-functional ester wax. Examples of the aliphatic ester wax are as follows. Here, the functionality indicates the number of ester groups contained per molecule. For example, behenyl behenate is monofunctional ester wax, and dipentaerythritol hexabehenate is hexafunctional ester wax.

As mentioned above, the toner particle can contain an ester wax. The ester wax can be a polyfunctional ester wax having two or more ester groups and can be a difunctional ester wax having two ester groups.

Examples of the monofunctional aliphatic ester wax include condensates formed between monocarboxylic acids having 4 to 28 carbon atoms and monoalcohols having 4 to 28 carbon atoms. For example, at least one selected from the group consisting of stearyl stearate, behenyl stearate, stearyl behenate, and behenyl behenate can be used, or at least one selected from the group consisting of behenyl behenate and stearyl behenate can be used.

Examples of the difunctional aliphatic ester wax include condensates of dicarboxylic acids and monoalcohols, and condensates of diols and monocarboxylic acids.

Examples of the dicarboxylic acids include adipic acid, pimelic acid, suberic acid, azelaic acid, sebacic acid, and dodecanedioic acid.

Examples of the diols include ethylene glycol, 1,6-hexanediol, 1,7-heptanediol, 1,8-octanediol, 1,9-nonanediol, 1,10-decanediol, 1,11-undecanediol, and 1,12-dodecanediol.

An example of the monoalcohol to be condensed with a dicarboxylic acid can be an aliphatic alcohol. Specific examples thereof include tetradecanol, pentadecanol, hexadecanol, heptadecanol, octadecanol, nonadecanol, eicosanol, docosanol, tricosanol, tetracosanol, pentacosanol, hexacosanol, and octacosanol.

Examples of the monocarboxylic acid to be condensed with a diol include lauric acid, myristic acid, palmitic acid, margaric acid, stearic acid, tuberculin stearic acid, arachidic acid, behenic acid, lignoceric acid, and cerotic acid.

Examples of the trifunctional ester wax include condensates formed between glycerin compounds and monofunctional aliphatic carboxylic acids.

Examples of the tetrafunctional ester wax include condensates formed between pentaerythritol and monofunctional aliphatic carboxylic acids and condensates of diglycerin and aliphatic carboxylic acids. Examples of the pentafunctional ester wax include condensates formed between triglycerin and monofunctional aliphatic carboxylic acids.

Examples of the hexafunctional ester wax include condensates formed between dipentaerythritol and monofunctional aliphatic carboxylic acids and condensates formed between tetraglycerin and monofunctional aliphatic carboxylic acids.

The amount of the release agent contained relative to 100.0 parts by mass of the binder resin can be 1.0 parts by mass or more and 30.0 parts by mass or less. The amount of the ester wax contained in the toner particle relative to 100 parts by mass of the binder resin can be 1.0 to 10.0 parts by mass or can be 2.0 to 8.0 parts by mass.

### Coloring Agent

The toner particle may contain a coloring agent. Known pigments and dyes can be used as the coloring agent. A pigment can be used as the coloring agent for its excellent weather resistance.

Examples of the cyan coloring agent include copper phthalocyanine compounds and derivatives thereof, anthraquinone compounds, and basic dye lake compounds.

Specific examples are as follows. C.I. Pigment Blue 1, 7, 15, 15:1, 15:2, 15:3, 15:4, 60, 62, and 66.

Examples of the magenta coloring agent include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specific examples are as follows. C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I. Pigment Violet 19.

Examples of the yellow coloring agent include condensed azo compounds, isoindolinone compounds, anthraquinone compounds, azo metal complexes, methine compounds, and arylamide compounds.

Specific examples are as follows. C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of the black coloring agent include coloring agents adjusted to exhibit black by using the yellow coloring agents, the magenta coloring agents, and the cyan coloring agents described above, carbon black, and magnetic materials.

These coloring agents can be used alone or as a mixture, or can be used in a solid solution state. The amount of the coloring agent used relative to 100.0 parts by mass of the binder resin can be 1.0 parts by mass or more and 20.0 parts by mass or less. Note that when a production method that involves using a magnetic material in the water-based medium described below is adopted, a hydrophobization treatment may be performed for the purpose of stably incorporating the magnetic material in the resin.

### Average Circularity of Toner Particle

The average circularity of the toner particle can be 0.960 or more and 0.995 or less. When the average circularity of the toner particle is within the aforementioned range, the charge rising property is improved. The method for measuring the average circularity of the toner particle is described below.

### Method for Producing Toner Particle

The method for producing a toner particle is not particularly limited, and a known method such as a pulverization method, a suspension polymerization method, a dissolution suspension method, an emulsion aggregation method, or a dispersion polymerization method, may be used. Among these, a suspension polymerization method can be used since the average circularity of the toner particle can be highly controlled, and high flowability and chargeability are exhibited.

The weight average particle diameter (D4) of the toner particle can be 4.0 to 12.0 μm or can be 5.0 to 10.0 μm.

### Method for Measuring Physical Properties

Next, methods for measuring physical properties are described.

Method for Separating Toner Particle, Metal Titanate Compound Fine Particle A, Silica Fine Particle B, and Inorganic Fine Particle C from Toner

In order to measure the physical properties of the metal titanate compound fine particle A, the silica fine particle B, the inorganic fine particle C, and the toner particle, separation from the toner is performed according to the following procedure and then the physical properties can be measured.

Into 1 L of deionized water, 1.6 kg of sucrose (produced by KISHIDA CHEMICAL CO., LTD.) is added and dissolved over hot water to prepare a sucrose concentrate. Into a centrifugation tube, 31 g of the sucrose concentrate and 6 mL of Contaminon N (produced by Wako Pure Chemical Corporation, a 10 mass % aqueous solution of a pH 7 neutral detergent for precision measuring instruments, containing a nonionic surfactant, an anionic surfactant, and an organic builder) are placed, and a dispersion is prepared. To this dispersion, 10 g of a toner is added, and lumps of the toner are loosened by using a spatula or the like.

The centrifugation tube is loaded into “KM Shaker” (model: V. SX) produced by Iwaki Industry Co., Ltd., and is shaken for 20 minutes under the condition of 350 reciprocal motions per minute. After shaking, the solution is re-placed into a glass tube (50 mL) for a swing rotor and is centrifuged with a centrifuge under the conditions of 3500 rpm for 30 minutes.

In the glass tube after the centrifugation, the toner particle is present in the upper-most layer, and a fine particle mixture of the metal titanate compound fine particle A, the silica fine particle B, and the inorganic fine particle C is present on the aqueous solution-side in the lower layer. The aqueous solution in the upper layer and the aqueous solution of the lower layer are separated and are each dried to obtain a toner particle from the upper layer side and a fine particle mixture from the lower layer side. The aforementioned centrifugation process is repeated until a total of 10 g or more of the fine particle mixture is obtained from the lower layer side.

Subsequently, 10 g of the obtained fine particle mixture is added to a dispersion containing 100 mL of deionized water and 6 mL of Contaminon N described above and is dispersed. The obtained dispersion is re-placed into a glass tube (50 mL) for a swing rotor and is centrifuged with a centrifuge under the conditions of 3500 rpm for 30 minutes.

In the glass tube after the centrifugation, a silica fine particle B and an inorganic fine particle C are present in the upper-most layer, and the metal titanate compound fine particle A is present on the aqueous solution side in the lower layer. The aqueous solution in the lower layer is taken and dried to separate and collect the metal titanate compound fine particle A. The aqueous solution in the upper layer is taken and repeatedly centrifuged as necessary for thorough separation, and then the dispersion is dried to collect a silica fine particle B and an inorganic fine particle C.

### Method for Measuring Amounts of Metal Titanate Compound Fine Particle a, Silica Fine Particle B, and Inorganic Fine Particle C Contained

The toner particle, the metal titanate compound fine particle A, the silica fine particle B, and the inorganic fine particle C are separated from the toner by the aforementioned method. The masses of the obtained toner particle, metal titanate compound fine particle A, silica fine particle B, and inorganic fine particle C are measured. Then the amount of each material contained relative to 100 parts by mass of the toner particle is calculated from the obtained masses of the toner particle, the metal titanate compound fine particle A, the silica fine particle B, and the inorganic fine particle C.

When the inorganic fine particle C is a silica fine particle and it is difficult to separate the silica fine particle B and the inorganic fine particle C from each other, the masses of the silica fine particle B and the inorganic fine particle C are calculated by the following method. Let the product of the Feret minimum diameter D_{B} of the silica fine particle B and the coverage ratio S_{B} obtained by the method described below be represented by X_{B}, and let the product of the Feret minimum diameter D_{C} of the silica fine particle C serving as the inorganic fine particle C and the coverage ratio S_{C} be represented by X_{C}. By using X_{B} and X_{C}, the masses of the silica fine particle B and the inorganic fine particle C are calculated from the following equations.

Mass of silica fine particle B=(total mass of silica fine particle B and inorganic fine particle C)×X_{B}/(X_{B}+X_{C})

Mass of inorganic fine particle C=(total mass of silica fine particle B and inorganic fine particle C)×X_{C}/(X_{B}+X_{C})

### Method for Calculating Feret Minimum Diameters of Primary Particles of Metal Titanate Compound Fine Particle A, Silica Fine Particle B, and Inorganic Fine Particle C and Coverage Ratios

The Feret minimum diameters of the primary particles of the metal titanate compound fine particle A, the silica fine particle B, and the inorganic fine particle C and the coverage ratios are calculated by image analysis combining secondary electron images and backscattered electron images obtained by SEM observation and element mapping images obtained by EDX spectroscopy. Details are as follows.

### Method for Acquiring Secondary Electron Image and Backscattered Electron Image of Toner Particle

A secondary electron image and a backscattered electron image of the toner particle are simultaneously acquired in the same view area by using the following instrument.
Instrument used: ULTRA PLUS produced by Carl Zeiss Microscopy GmbH
Acceleration voltage: 0.7 kV
WD: 2.5 mm
Aperture Size: 30.0 μm
Secondary electron image detected signal: SED (secondary electron)
Backscattered electron image detected signal: EsB (energy selecting backscattered electron)
EsB grid: 400 V
Observation magnification: 100,000×
Contrast: 63.0±5.0% (reference value)
Brightness: 38.0±5.0% (reference value)
Resolution: 1024×768 pixel
Pretreatment: Toner is sprayed onto a carbon tape (No Pt deposition)

The contrast and brightness are set, as appropriate, according to the status of the instrument used. The acceleration voltage and EsB grid are set to achieve such items as acquisition of the structural information on the outermost surface of the toner particle, prevention of charge-up of undeposited specimens, and selective detection of high-energy backscattered electrons. A site where the curvature of the toner particle is small is selected as the observation view area.

### Conditions for Acquiring Element Mapping Image of Toner Particle

After acquiring the secondary electron image and the backscattered electron image, SEM-EDX is used to acquire an element mapping image of the toner particle in the same view area as the secondary electron image and the backscattered electron image. Conditions for acquiring the element mapping image of the toner particle are as follows.
EDX detector: JEOL Ltd., JED-2300T Dry S_{D}100GV detector (detection element area: 100 mm²)
EDS analyzer: NORAN System 7 produced by Thermo Fisher Scientific Inc.
Drift correction factor: 4
Dwell time: 30 s
Number of runs: 100 frames
X-ray count rate: 4000 to 10000 cps
Element mapping image size: 256×256 pixel

The spectrum mapping data collected under the above-described conditions are processed by using a quantitative map mode in the measurement command of NORAN System 7 described above to extract the quantitative map images of the individual elements (Ti, Sr, Ba, Ca, Si, Al, and O). For this, the set values are as follows.
Kernel size: 3×3
Quantitative map setting: high (slow)
Filter fit type: high precision (slow)

### Method for Calculating Feret Minimum Diameter of Primary Particles and Coverage Ratio

First, a secondary electron image and a backscattered electron image of the toner particle surface are acquired under the same view area. In the backscattered electron image acquired under the aforementioned conditions, fine particles present on the toner particle surface can be identified in a simplified manner from the brightness threshold in each pixel. Examples are as follows.
Brightness threshold of metal titanate compound fine particles (175 to 200 (256 levels, reference value))
Brightness threshold of silica fine particles (85 to 128 (256 levels, reference value))
Brightness threshold of titania fine particles (140 to 160 (256 levels, reference value))
Brightness threshold of alumina fine particles (75 to 115 (256 levels, reference value))

Then the element mapping image is acquired for each element in the same view area as the secondary electron image and the backscattered electron image, and the acquired element mapping images are superimposed. In the superimposed element mapping images, portions where Ti overlaps Sr, Ba, Ca, etc., indicate metal titanate compound fine particles present on the toner particle surface. Next, fine particles other than the metal titanate compound fine particles present on the toner particle surface are identified. In the superimposed element mapping images, portions where Si overlaps O indicate silica fine particles, portions where Ti overlaps O indicate titania fine particles, and portions where Al overlaps O indicate alumina fine particles.

The Feret minimum diameter of primary particles for each of fine particles can be calculated by analyzing the backscattered electron image of the toner particle obtained as above by using image processing software, ImageJ (developed by Wayne Rashand). The procedure of the calculation is as follows.

First, Type is selected from Image menu to convert the backscattered electron image to be analyzed into 8-bit. Next, Filters is selected from Process menu, and Median diameter is set to 2.0 pixel to cut image noise. Next, Rectangle Tool in the tool bar is used to select the entire backscattered electron image. Then Threshold is selected from Adjust in Image menu to adjust the brightness threshold in the aforementioned backscattered electron image to that described above. In addition, Analyze Particles is selected from Analyze menu, Masks is selected as the output image, and a binary image is output for each separated fine particle. When it is difficult to separate fine particles from each other by using the brightness thresholds in the backscattered electron image, positions corresponding to metal titanate compound fine particles, silica fine particles, titania fine particles, and alumina fine particles are identified from the binarized image and the element mapping image acquired in the same view area, and the binarized image is divided according to individual fine particles. The obtained binarized image and the secondary electron image measured in the same view area are superimposed, the contours of the fine particles are identified by the aforementioned secondary electron image, and a binarized image divided according to individual fine particles is output.

This output binarized image is selected, and Area and Feret's diameter are selected from Set Measurements in Analyze menu. Measure in Analyze menu is then executed to calculate the Feret minimum diameter (nm) of primary particles and area (nm²) of each fine particle. For each of the obtained fine particles, the Feret minimum diameters of primary particles are counted at 2 nm intervals, and a number-based particle size distribution graph with a horizontal axis indicating the Feret minimum diameter of the primary particle and a vertical axis indicating frequency is plotted. In the obtained particle size distribution graph, the median of the Feret minimum diameter at the maximum frequency is assumed to be the peak value (nm). In addition, the ratio of the sum of the areas of the primary particles of each types of fine particle present in the binarized image to the area of the entire binarized image is assumed to be the a coverage ratio (area %) of that type of fine particle.

When the inorganic fine particle C is a silica fine particle, the Feret minimum diameters (nm) of the primary particles and the areas (nm²) of the silica fine particle B and the inorganic fine particle C are calculated according to the following procedure. In the particle size distribution of the silica fine particles prepared by the method described above, the peak value at which the frequency is highest and the peak value at which the frequency is second highest are identified. Of these two peak values, the peak value on the small diameter side is defined as a Feret minimum diameter D_{B} of the primary particles of the silica fine particle B, and the peak value on the large diameter side is defined as a Feret minimum diameter D_{C} of the primary particles of the inorganic fine particle C. Here, the Feret minimum diameter at which the frequency is the smallest between the two peak values is used as a threshold, particles having a Feret minimum diameter smaller than the threshold are defined as silica fine particle B, and large-diameter-side fine particles having a Feret minimum diameter equal to or greater than the threshold are defined as silica fine particles that serve as the inorganic fine particle C. After the silica fine particle B and the silica fine particles serving as the inorganic fine particle C are separated from each other by the aforementioned method, the area and the coverage ratio are calculated for each type of fine particles.

The aforementioned procedure is conducted for 20 view areas for the toner particle to be evaluated, and the arithmetic averages of the obtained 20 calculated values are assumed to be the peak value of each type of fine particles and the coverage ratio of the toner particle by each type of fine particles.

### Solid-State ²⁹Si-NMR CP-MAS Measurement Method on Metal Titanate Compound Fine Particle A

Solid-state ²⁹Si-NMR CP-MAS measurement is performed on the aforementioned separated metal titanate compound fine particle A serving as a specimen. Measurement instrument and measurement conditions are as follows.
Instrument: JNM-ECX5002 (JEOL RESONANCE)
Temperature: room temperature
Measurement method: CP/MAS method, ²⁹Si 450
Specimen tube: zirconia 8.0 mmφ
Specimen: in a powder state and packed in a test tube
Specimen rotation speed: 10 kHz
Relaxation delay: 180 s
Scan: 2000
Standard substance for calibration: DSS (sodium 3-(trimethylsilyl)-1-propanesulfonate)

A solid-state ²⁹Si-NMR spectrum obtained by a solid-state ²⁹Si-NMR CP/MAS spectroscopy on the metal titanate compound fine particle A serving as a specimen is separated into a peak D assigned to a D unit structure described below and a peak T assigned to a T unit structure by curve-fitting multiple silane components with different substituents and bonding groups.

Curve fitting is performed by using NMR analysis software “Delta Software” produced by JEOL Ltd. From the menu icons, “1D Pro” is clicked to retrieve spectroscopy data. Next, “Curve fitting function” is selected from “Command” in the menu bar, and curve fitting is performed. Curve fitting is performed for each of the components so that the difference between a composite peak obtained by combining the peaks obtained by the curve fitting and a peak of the measurement data (composite peak difference) is minimum.

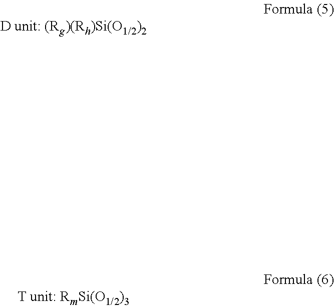

In formulae (5) and (6), R_{g}, Rₕ, and Rₘ each represent a hydrocarbon group having 1 or more carbon atoms, a halogen atom, etc., that are bonded to silicon.

The peak D has a chemical shift in the range of −25 ppm to −15 ppm. The area of the peak D with a chemical shift in the range of −30 ppm to 0 ppm with respect to the peak D is defined as S_{D}. Here, S_{D} is an integral value of the region sandwiched by the solid-state ²⁹Si-NMR spectrum and the base line. When the arithmetic average of the intensity value at a chemical shift of 40 ppm to 60 ppm is represented by B1 and the arithmetic average of the intensity value at a chemical shift of −120 ppm to −100 ppm is represented by B2, the base line is a line segment that connects the plot of the intensity value B1 at a chemical shift of 50 ppm to a plot of the intensity value B2 at a chemical shift of −110 ppm.

The peak T has a chemical shift in the range of −70 ppm to −50 ppm. The peak T is further separated into a peak X2 present in the range of −60 ppm to −50 ppm and a peak X3 present in the range of −70 ppm to −60 ppm by using the Voigt function. For the peak X2 and the peak X3, the area of the peak X2 in a chemical shift range of −60 ppm to −40 ppm is defined as S_{X2} and the integral value of the peak X3 in the chemical shift range of −80 ppm to −60 ppm is defined as S_{X3}. Here, S_{X2} and S_{X3} are integral values of a region sandwiched by the solid-state ²⁹Si-NMR spectrum and the base line. From the calculated S_{D}, S_{X2}, and S_{X3}, S_{D}/(S_{X2}+S_{X3}) is calculated.

### Method for Measuring Fragment Ion on Metal Titanate Compound Fine Particle Surfaces by Time-of-Flight Secondary Ion Mass Spectrometry (TOF-SIMS)

In TOF-SIMS, the metal titanate compound fine particle A separated from the toner by the method described above are used as a specimen. TRIFT-IV produced by ULVAC-PHI, INCORPORATED, is used as the measurement instrument. The spectroscopy conditions are as follows.

Sample preparation: metal titanate compound fine particle A are attached to an indium sheet.
Primary ion: Au ion
Acceleration voltage: 30 kV
Charge neutralization mode: ON
Measurement mode: Positive
Raster: 200 μm
Measurement time: 60 s

Whether a fragment ion that corresponds to the structure represented by formula (1) is observed is confirmed through the obtained secondary ion mass/secondary ion charge count (m/z) mass profile. For example, when the surface treating agent is polydimethylsiloxane, fragment ions are observed at positions such as m/z=147, 207, and 221.

### Method for Measuring Average Circularity of Toner

The average circularity of the toner is measured and analyzed by using a flow-type particle image analyzer (trade name: FPIA-3000 produced by Sysmex Corporation). A specific measurement method is as follows.

First, 20 mL of deionized water is placed in a glass container from which impurity solid matter and the like have been removed in advance. Thereto, 0.2 mL of a diluted solution prepared by diluting Contaminon N (trade name, produced by Wako Pure Chemical Corporation, a 10 mass % aqueous solution of a pH 7 neutral detergent for precision measurement instruments, containing a nonionic surfactant, an anionic surfactant, and an organic builder) by a factor of 3 by mass with deionized water is added as a dispersing agent.

Thereto, 0.02 g of a measurement specimen is further added, and the resulting mixture is dispersed for 2 minutes with an ultrasonic disperser to prepare a dispersion for measurement. During this process, the dispersion is cooled as appropriate so that the temperature thereof is 10° C. or higher and 40° C. or lower. A tabletop-type ultrasonic cleaner/disperser having an oscillation frequency of 50 kHz and an electrical output of 150 W (for example, “VS-150” (produced by VELVO-CLEAR)) is used as the ultrasonic disperser, a predetermined amount of deionized water is placed in a vessel, and 2 mL of Contaminon N is added to this vessel.

For measurement, a flow-type particle image analyzer equipped with “UPlanApro” (magnification: 10×, numerical aperture: 0.40) as an objective lens is used, and a particle sheath (trade name: PSE-900A, produced by Sysmex Corporation) is used as the sheath fluid. The dispersion prepared according to the procedure described above is introduced into the flow-type particle image analyzer, and 3000 of the toner particle are measured in the HPF measurement mode and the total count mode. Then the binarization threshold for particle analysis is set to 85%, the analysis particle diameter is limited to a circle-equivalent diameter of 1.985 μm or more and less than 39.69 μm, and the average circularity of the toner particle is determined.

Before start of the measurement, autofocus adjustment is performed by using standard latex particles (for example, “RESEARCH AND TEST PARTICLES Latex Microsphere Suspensions 5200A” (produced by Duke Scientific) diluted with deionized water).

### Measurement of Amount of Carbon Atoms (C Amount) in Metal Titanate Compound Fine Particle A

The C amount derived from the treatment agent for the metal titanate compound fine particle A is measured by using a carbon/sulfur analyzer (trade name: EMIA-320) produced by HORIBA, Ltd.

0.3 g of the sample, that is, the metal titanate compound fine particle A, is precisely weighed and placed in a crucible for the carbon/sulfur analyzer. Thereto, 0.3±0.05 g of tin (supplementary part number: 9052012500) and 1.5±0.1 g of tungsten (supplementary part number: 9051104100 are added.

Then, in accordance with the description in the manual of the carbon/sulfur analyzer, metal titanate compound fine particles are heated in an oxygen atmosphere at 1100° C. As a result, hydrophobic groups derived from the hydrophobizing agent on the surfaces of the metal titanate compound fine particle A are pyrolyzed into CO₂, and the amount thereof is measured. The C amount (mass %) in the metal titanate compound fine particle A is determined from the obtained amount of CO₂.

### EXAMPLES

The toner of the present disclosure will now be described in detail by using Examples and Comparative Examples, but the present disclosure is not limited by these examples. It should be noted that in the description of the examples below, “parts” is on a mass basis unless otherwise noted.

### Production Example of Metal Titanate Compound Fine Particle A1

After metatitanic acid produced by a sulfuric acid method was subjected to an iron-removal bleaching treatment, the pH was adjusted to 9.0 by adding a 3 mol/L aqueous sodium hydroxide solution, and the resulting mixture was desulfurized, neutralized to a pH of 5.6 by using 5 mol/L hydrochloric acid, and filtered and washed with water. To the washed cake, water was added to prepare a 1.90 mol/L slurry of TiO₂, and hydrochloric acid was added thereto to adjust the pH to 1.4 and to perform a peptization treatment.

1.90 mol (as TiO₂) of metatitanic acid subjected to the desulfurization and peptization was collected and placed in a 3 L reactor. To the peptized metatitanic acid slurry, 2.185 mol of an aqueous strontium chloride solution was added so that the SrO/TiO₂ molar ratio was 1.15, and then the TiO₂ concentration was adjusted to 1.039 mol/L. Next, the resulting mixture was heated to 90° C. while being stirred and mixed, 440 mL of a 10 mol/L aqueous sodium hydroxide solution was added thereto over a period of 40 minutes, and then the resulting mixture was stirred for 30 minutes at 95° C. and rapidly cooled by being put in ice water to terminate the reaction.

The resulting reaction slurry was heated to 70° C., 12 mol/L hydrochloric acid was added thereto until the pH reached 5.0, followed by stirring for 1 hour, and then the obtained precipitates were decanted. The slurry containing the obtained precipitates was adjusted to 40° C., hydrochloric acid was added to adjust the pH to 2.5, and then 5.0 mass % of isobutyltrimethoxysilane relative to the solid content was added thereto, followed by stirring for 10 hours. Then 2.0 mass % of a dimethylsilicone oil having a viscosity of 1.0×10⁻³ m²/s relative to the solid content was added, followed by stirring for 10 hours. The pH was adjusted to 6.5 by adding a 5 mol/L aqueous sodium hydroxide solution, the resulting mixture was continuously stirred for 1 hour and then filtered and washed, and the obtained cake was dried in air at 120° C. for 8 hours to obtain metal titanate compound fine particle A1. The physical properties of the obtained metal titanate compound fine particle A1 are indicated in Table 1-2.

### Production Examples of Metal Titanate Compound Fine Particle A2 to A24

Metal titanate compound fine particle A2 to A24 were produced as in Production example of titanate compound fine particle A1 except that the metal atoms of the metal titanate compound fine particle bases, the type and the treatment amount of the silane coupling agent, and the treatment amount of the silicone oil were changed as indicated in Table 1-1. The physical properties are indicated in Table 1-2.

### Production Example of Titanium Oxide Fine Particle

Into 500 mL of deionized water, 50 g of titanium oxide fine particles (titanium oxide fine particle bases) having a number average particle diameter of 30 nm were dispersed. To the obtained dispersion of the titanium oxide fine particles, 5 mol/L hydrochloric acid was added to adjust the pH of the dispersion of the titanium oxide fine particles to 3 or more and 4 or less. To the dispersion of the titanium oxide fine particles with the adjusted pH, 5.0 mass % of isobutyltrimethoxysilane relative to the solid content was added, followed by stirring for 10 hours. Then 2.0 mass % of a dimethylsilicone oil having a viscosity of 1.0×10⁻³ m²/s relative to the solid content was added, followed by stirring for 10 hours. The dispersion of the titanium oxide fine particles after stirring was placed in a separable flask having a volume of 1 L. Next, the dispersion of the titanium oxide fine particles in the flask was reacted at 70° C. for 30 minutes. The pH was adjusted to 6.5 by adding a 5 mol/L aqueous sodium hydroxide solution, the resulting mixture was continuously stirred for 1 hour and then filtered and washed, and the obtained cake was dried in air at 120° C. for 8 hours to obtain titanium oxide fine particles 1. The physical properties of the obtained titanium oxide fine particles 1 were as follows: C amount: 1.60 (mass %), S_{D}: 1.00, S_{X2}: 1.30, S_{X3}: 1.60, S_{D}/(S_{X2}+S_{X3}): 0.34.

TABLE 1-1

| | | Silane coupling agent | | Silicone oil |
|---|---|---|---|---|
| | | | Treatment | Treatment |
| | | | amount | amount |
| | Metal atom | Type | (mass %) | (mass %) |
| Metal titanate compound fine particle 1 | Sr | Isobutyltrimethoxysilane | 5.0 | 2.0 |
| Metal titanate compound fine particle 2 | Sr | Isobutyltrimethoxysilane | 5.0 | 3.0 |
| Metal titanate compound fine particle 3 | Sr | Isobutyltrimethoxysilane | 5.0 | 1.0 |
| Metal titanate compound fine particle 4 | Sr | Isobutyltrimethoxysilane | 4.0 | 3.0 |
| Metal titanate compound fine particle 5 | Sr | Isobutyltrimethoxysilane | 3.0 | 3.0 |
| Metal titanate compound fine particle 6 | Sr | Isobutyltrimethoxysilane | 15.0 | 2.0 |
| Metal titanate compound fine particle 7 | Sr | Isobutyltrimethoxysilane | 15.0 | 7.0 |
| Metal titanate compound fine particle 8 | Sr | Isobutyltrimethoxysilane | 5.0 | 0.0 |
| Metal titanate compound fine particle 9 | Sr | Isobutyltrimethoxysilane | 1.5 | 10.0 |
| Metal titanate compound fine particle 10 | Sr | Isobutyltrimethoxysilane | 10.0 | 4.0 |
| Metal titanate compound fine particle 11 | Sr | Isobutyltrimethoxysilane | 5.0 | 2.0 |
| Metal titanate compound fine particle 12 | Sr | Isobutyltrimethoxysilane | 10.0 | 4.0 |
| Metal titanate compound fine particle 13 | Sr | Isobutyltrimethoxysilane | 5.0 | 2.0 |
| Metal titanate compound fine particle 14 | Sr | n-Propyltrimethoxysilane | 5.0 | 3.0 |
| Metal titanate compound fine particle 15 | Sr | n-Butyltrimethoxysilane | 5.0 | 3.0 |
| Metal titanate compound fine particle 16 | Sr | n-Hexyltrimethoxysilane | 5.0 | 3.0 |
| Metal titanate compound fine particle 17 | Sr | Octyltrimethoxysilane | 5.0 | 3.0 |
| Metal titanate compound fine particle 18 | Sr | Octyltriethoxysilane | 5.0 | 3.0 |
| Metal titanate compound fine particle 19 | Sr | Ethyltrimethoxysilane | 5.0 | 3.0 |
| Metal titanate compound fine particle 20 | Sr | Isobutyltrimethoxysilane/ | 5.0/5.0 | 0.0 |
| | | Hexyltrimethoxysilane | | |
| Metal titanate compound fine particle 21 | Sr | n- | 5.0/5.0 | 0.0 |
| | | Propyltrimethoxysilane/ | | |
| | | octyltriethoxysilane | | |
| Metal titanate compound fine particle 22 | Ba | Isobutyltrimethoxysilane | 5.0 | 2.0 |
| Metal titanate compound fine particle 23 | Sr | Isobutyltrimethoxysilane | 15.0 | 1.0 |
| Metal titanate compound fine particle 24 | Sr | None | 0.0 | 10.0 |

Abbreviations in Table 1-1 are as follows.
Sr: strontium
Ba: barium

TABLE 1-2

| | Physical properties | | | | | |
|---|---|---|---|---|---|---|
| | Number- | | | | | |
| | average | | | | | |
| | particle | C | | | | |
| | diameter | amount | | | | |
| | (nm) | (mass %) | S_{D} | S_{X2} | S_{X3} | S_{D}/(S_{X2} + S_{X3}) |
| Metal titanate compound fine particle 1 | 30 | 1.53 | 1.50 | 1.30 | 1.40 | 0.56 |
| Metal titanate compound fine particle 2 | 30 | 1.78 | 2.00 | 1.10 | 1.50 | 0.77 |
| Metal titanate compound fine particle 3 | 30 | 1.20 | 0.80 | 1.30 | 1.00 | 0.35 |
| Metal titanate compound fine particle 4 | 30 | 1.59 | 1.80 | 0.80 | 1.00 | 1.00 |
| Metal titanate compound fine particle 5 | 30 | 1.37 | 1.80 | 0.50 | 0.85 | 1.33 |
| Metal titanate compound fine particle 6 | 30 | 3.86 | 0.40 | 1.50 | 2.40 | 0.10 |
| Metal titanate compound fine particle 7 | 30 | 4.87 | 2.00 | 1.50 | 2.60 | 0.49 |
| Metal titanate compound fine particle 8 | 30 | 1.04 | 0.00 | 1.40 | 0.50 | 0.00 |
| Metal titanate compound fine particle 9 | 30 | 2.25 | 0.50 | 0.10 | 0.20 | 1.67 |
| Metal titanate compound fine particle 10 | 5 | 3.70 | 2.10 | 0.80 | 1.00 | 1.17 |
| Metal titanate compound fine particle 11 | 50 | 1.35 | 1.00 | 1.30 | 1.60 | 0.34 |
| Metal titanate compound fine particle 12 | 3 | 3.90 | 2.10 | 0.50 | 1.00 | 1.40 |
| Metal titanate compound fine particle 13 | 70 | 1.20 | 0.60 | 0.80 | 0.90 | 0.35 |
| Metal titanate compound fine particle 14 | 70 | 1.78 | 2.00 | 0.60 | 1.00 | 1.25 |
| Metal titanate compound fine particle 15 | 70 | 1.80 | 1.80 | 0.45 | 0.85 | 1.38 |
| Metal titanate compound fine particle 16 | 70 | 1.90 | 1.70 | 0.40 | 0.80 | 1.42 |
| Metal titanate compound fine particle 17 | 70 | 1.55 | 1.50 | 0.40 | 0.60 | 1.50 |
| Metal titanate compound fine particle 18 | 70 | 1.68 | 1.50 | 0.60 | 0.40 | 1.50 |
| Metal titanate compound fine particle 19 | 70 | 1.20 | 2.00 | 1.00 | 0.35 | 1.48 |
| Metal titanate compound fine particle 20 | 30 | 1.10 | 0.00 | 1.30 | 0.50 | 0.00 |
| Metal titanate compound fine particle 21 | 30 | 1.20 | 0.00 | 1.60 | 0.50 | 0.00 |
| Metal titanate compound fine particle 22 | 30 | 1.56 | 1.50 | 1.30 | 1.40 | 0.56 |
| Metal titanate compound fine particle 23 | 30 | 3.75 | 0.30 | 2.00 | 1.60 | 0.08 |
| Metal titanate compound fine particle 24 | 30 | 1.60 | 0.10 | 0.00 | 0.00 | — |

### Production Example of Silica Fine Particle B1

Untreated dry silica (fumed silica, BET specific surface area: 200 m²/g) was placed in a reactor and heated to 330° C. while being put in a fluidized state created by stirring. Then 20 parts of a dimethylsilicone oil (polydimethylsiloxane, KF-96-50CS produced by Shin-Etsu Chemical Co., Ltd.) serving as a surface treating agent was sprayed onto 100 parts of untreated dry silica. Subsequently, heating and stirring were continued for 1 hour to induce reaction to perform a coating treatment, as a result of which a silica fine particle B1 were obtained. The physical properties of the obtained silica fine particle B1 are indicated in Table 2.

### Production Examples of Silica Fine Particles B2 to B6

Silica fine particles B2 to B6 were obtained as in Production example of silica fine particle B1 except that the BET specific surface area of the untreated dry silica and the number of parts of the surface treating agent were changed as indicated in Table 2. The physical properties are indicated in Table 2.

TABLE 2

| | Fine particle bases | | Silicone oil | Physical properties |
|---|---|---|---|---|
| | | BET specific | treatment | Number-average |
| | | surface area | amount | particle diameter |
| | Type | (m²/g) | (mass %)) | (nm) |
| Silica fine particle B1 | Fumed silica | 200 | 20 | 20 |
| Silica fine particle B2 | Fumed silica | 380 | 30 | 5 |
| Silica fine particle B3 | Fumed silica | 300 | 30 | 10 |
| Silica fine particle B4 | Fumed silica | 100 | 15 | 30 |
| Silica fine particle B5 | Fumed silica | 70 | 7 | 40 |
| Silica fine particle B6 | Fumed silica | 30 | 6 | 100 |

### Production Example of Inorganic Fine Particle C1

Untreated dry silica (fumed silica, BET specific surface area: 30 m²/g) was placed in a reactor and heated to 330° C. while being put in a fluidized state created by stirring. Then 20 parts of a dimethylsilicone oil (polydimethylsiloxane, KF-96-50CS produced by Shin-Etsu Chemical Co., Ltd.) serving as a surface treating agent was sprayed onto 100 parts of untreated dry silica. Subsequently, heating and stirring were continued for 1 hour to induce reaction to perform a coating treatment, as a result of which a inorganic fine particle C1 was obtained. The physical properties of the obtained inorganic fine particle C1 are indicated in Table 3.

### Production Example of Inorganic Fine Particles C2 to C7

Inorganic fine particles C2 to C7 were obtained as in Production example of inorganic fine particle C1 except that the type of the fine particle bases and the BET specific surface area were changed as indicated in Table 3, and the physical properties thereof are indicated in Table 3.

TABLE 3

| | Fine particle bases | | Physical properties | |
|---|---|---|---|---|
| | | BET specific | Number-average | Vickers |
| | | surface area | particle diameter | hardness |
| | Type | (m²/g) | (nm) | (GPa) |
| Inorganic fine particle C1 | Fumed silica | 30 | 100 | 9.5 |
| Inorganic fine particle C2 | Fumed silica | 40 | 75 | |
| Inorganic fine particle C3 | Fumed silica | 50 | 50 | |
| Inorganic fine particle C4 | Fumed silica | 10 | 300 | |
| Inorganic fine particle C5 | Fumed silica | 3 | 990 | |
| Inorganic fine particle C6 | Titanium oxide | 12 | 200 | 8.6 |
| Inorganic fine particle C7 | Alumina | 10 | 300 | 16.0 |

### Production Example of Polyester Resin D1

Into a 6 L four-necked flask equipped with a nitrogen inlet tube, a dewatering tube, a stirrer, and a thermocouple, 100 parts by mass of a mixture prepared by mixing, at the charge ratios indicated in Table 4, the raw material monomers other than trimellitic anhydride, and 0.55 parts by mass of tin(II) 2-ethylhexanoate serving as a catalyst were charged, and the reaction was carried out in a nitrogen atmosphere at 200° C. for 6 hours. Furthermore, 1.8 parts by mass of trimellitic anhydride was added at 210° C., and the reaction was carried out at a reduced pressure of 40 kPa until the weight average molecular weight (Mw) reached 12,100. The obtained polyester resin was used as a polyester resin D1.

### Production Example of Polyester Resin D2

A polyester resin D2 was obtained as in Production example of polyester resin D1 except that the raw material monomers were changed as indicated in Table 4. The physical properties are indicated in Table 4.

TABLE 4

| | Raw material monomer charge ratios | | | | | | |
|---|---|---|---|---|---|---|---|
| | (molar ratios) | | | | | Resin physical properties | |
| | | | | | | | Weight average |
| | Acid | | Alcohol | | | Acid value | molecular weight |
| | TPA | TMA | BPA-PO | EG | Isosorbide | (mgKOH/g) | Mw |
| Polyester resin D1 | 43.00 | 1.30 | 30.00 | 18.00 | 2.00 | 3.9 | 12100 |
| Polyester resin D2 | 43.00 | 1.30 | 32.00 | 18.00 | — | 4.0 | 12100 |

Abbreviations in Table 4 are as follows.
TPA: terephthalic acid
TMA: trimellitic anhydride
BPA-PO: propylene oxide adduct of bisphenol A (Average number of moles added: 2.0 mol)
EG: ethylene glycol

### Production Example of Charge Control Resin E

Into 42.0 mL of DMF, 9.2 g of a polymerizable monomer represented by structural formula (9) below and 60.1 g of styrene were dissolved, and the resulting mixture was stirred for 1 hour under nitrogen bubbling and then heated to 110° C.

To the reaction solution, a mixture of 2.1 g of tert-butylperoxyisopropyl monocarbonate (trade name: PERBUTYL I produced by NOF CORPORATION) serving as an initiator and 42 mL of toluene was added dropwise. Upon completion of the dropwise addition, the reaction was carried out at 110° C. for 4 hours. Then the cooled reaction solution was added to 1 L of methanol dropwise to obtain precipitates. The obtained precipitates were dissolved in 120 mL of THF, the resulting solution was added to 1.80 L of methanol dropwise to allow white precipitates to occur, and the precipitates were filtered and dried at a reduced pressure at 90° C. to obtain a charge control resin E.

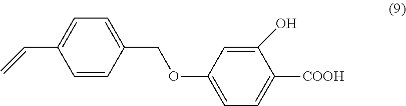 [SMILES: C=Cc1ccc(COc2ccc(C(=O)O)c(O)c2)cc1]

### Production Example of Toner Particle

A toner particle 1 was produced by the following procedure.

### Preparation of Pigment Masterbatch

The following materials were charged into an attritor (MITSUI MIIKE CHEMICAL MACHINERY CO., LTD.) and dispersed for 5 hours at 220 rpm with zirconia particles having a diameter of 1.7 mm to obtain a pigment masterbatch.
styrene: 60.0 parts
cyan pigment (C.I. Pigment Blue 15:3 produced by Dainichiseika Color & Chemicals Mfg. Co., Ltd.): 7 parts

### Preparation of First Aqueous Medium

Into 353.8 parts of deionized water, 2.9 parts of sodium phosphate dodecahydrate was added, the resulting mixture was heated to 60° C. under stirring by using a TK-type homomixer (produced by Tokushu Kika Kogyo Co., Ltd.), and an aqueous calcium chloride solution prepared by adding 1.7 parts of calcium chloride dihydrate in 11.7 parts of deionized water and an aqueous magnesium chloride solution prepared by adding 0.5 parts of magnesium chloride in 15.0 parts of deionized water were added thereto, and the resulting mixture was further stirred to obtain a first aqueous medium containing a dispersion stabilizer.

### Preparation of Polymerizable Monomer Composition

styrene: 15.0 parts
n-butyl acrylate: 25.0 parts
difunctional ester wax (ethylene glycol distearate): 5.0 parts
hydrocarbon wax (melting point: 79° C.): 5.0 parts
pigment masterbatch: 67.0 parts
polyester resin D1: 3.0 parts
charge control resin E: 0.5 parts

The aforementioned materials were homogeneously dispersed and mixed by using an attritor (produced by MITSUI MIIKE CHEMICAL MACHINERY CO., LTD.), then heated to 60° C., and dissolved to obtain a polymerizable monomer composition.

### Preparation of Second Aqueous Medium

Into 166.8 parts of deionized water, 0.6 parts of sodium phosphate dodecahydrate was added, the resulting mixture was heated to 60° C. under stirring by using a paddle stirring blade, an aqueous calcium chloride solution prepared by adding 0.3 parts of calcium chloride dihydrate to 2.3 parts of deionized water was added thereto, and the resulting mixture was further stirred to obtain a second aqueous medium containing a dispersion stabilizer.

### Particle Formation

To the aforementioned first aqueous medium, the aforementioned polymerizable monomer composition was added, and the resulting particle-forming liquid was treated for 1 hour in Cavitron (produced by Eurotec Ltd.) at a rotor peripheral speed of 29 m/s to be homogeneously dispersed and mixed. Thereto, 7.0 parts of t-butyl peroxypivalate was further added as a polymerization initiator, the resulting mixture was stirred at 60° C. in a N₂ atmosphere by using CLEARMIX (produced by Eurotec Ltd.) at a peripheral speed of 22 m/s for 10 minutes to form particles, and a particle-forming liquid containing droplets of a polymerizable monomer composition was obtained.

### Polymerization/Distillation/Drying

The particle-forming liquid was added to the second aqueous medium, and the resulting mixture was reacted at 74° C. for 3 hours under stirring with a paddle stirring blade. After termination of the reaction, the temperature was increased to 98° C., and distillation was performed for 3 hours to obtain a reaction slurry. Subsequently, as a cooling step, 0° C. water was added to the reaction slurry, and the reaction slurry was cooled at 100° C./minute from 98° C. to 45° C., then heated to 50° C., and maintained thereat for 3 hours.

Then the slurry was let cool to 25° C. at room temperature. The cooled reaction slurry was combined with hydrochloric acid to wash, was filtered, and was dried to obtain a toner particle 1 having a weight average particle diameter of 7.5 μm.

### Production Example of Toner Particle 2

A toner particle 2 having a weight average particle diameter of 7.6 μm was obtained as in Production example of toner particle 1 except that the polyester resin D1 was changed to a polyester resin D2.

### Production Example of Toner Particle 3

### Preparation of Styrene Acrylic Resin Particle Dispersion

styrene: 75 parts
n-butyl acrylate: 25 parts

The aforementioned materials were mixed and dissolved, a solution prepared by dissolving 1.0 part of an anionic surfactant (DAWFAX produced by The Dow Chemical Company) in 60 parts of deionized water was added thereto, and the resulting mixture was dispersed and emulsified in a flask to prepare an emulsion of monomers. Next, 2.0 parts of an anionic surfactant (DAWFAX produced by The Dow Chemical Company) was dissolved in 90 parts of deionized water, 2.0 parts of the aforementioned emulsion of the monomers was added thereto, and 10 parts of deionized water in which 1.0 part of ammonium persulfate was dissolved was further added thereto.

The remainder of the emulsion of the monomers was then added thereto over a period of 3 hours, the inside of the flask was nitrogen-purged, and the solution in the flask was heated over an oil bath until 65° C. under stirring. Emulsion polymerization was continued for 5 hours in this state, as a result of which a styrene acrylic acid resin particle dispersion was obtained. Deionized water was added to the styrene acrylic resin particle dispersion to adjust the solid content to 20 mass %.

### Preparation of Coloring Agent Particle Dispersion

cyan pigment (C.I. Pigment Blue 15:3 produced by Dainichiseika Color & Chemicals Mfg. Co., Ltd.): 35 parts
anionic surfactant (NEOGEN R produced by DKS Co. Ltd.): 2 parts
deionized water: 250 parts

The aforementioned materials were mixed and dissolved, and the resulting mixture was dispersed for about 1 hour by using a high-pressure impact-type disperser, Ultimizer (HJP30006 produced by SUGINO MACHINE LIMITED) to obtain a coloring agent particle dispersion. The volume average particle diameter of the particles in the coloring agent particle dispersion was 150 nm. Then deionized water was added to adjust the solid component concentration to 20 mass %.

### Preparation of Release Agent Particle Dispersion

paraffin wax (HNP-9 produced by Nippon Seiro Co., Ltd.): 200 parts
anionic surfactant (NEOGEN RK produced by DKS Co. Ltd.): 10.0 parts
deionized water: 20.0 parts

The aforementioned materials were mixed, the release agent was dissolved in a pressure discharge-type homogenizer (Gaulin homogenizer produced by Gaulin Company) at an inner liquid temperature of 120° C., and the resulting mixture was dispersed at a dispersion pressure of 5 MPa for 120 minutes and then at 40 MPa for 360 minutes, and was cooled to obtain a dispersion. Deionized water was added to adjust the solid component concentration to 20 mass %, as a result of which a release agent particle dispersion was obtained.

### Production of Toner Particle 3

styrene acrylic resin particle dispersion: 375 parts
coloring agent particle dispersion: 75 parts
release agent particle dispersion: 15 parts
deionized water: 750 parts
anionic surfactant (DOWFAX 2A1 produced by Dow Chemical Company): 3.2 parts

Into a 3 L reactor equipped with a thermometer, a pH meter, and a stirrer, the aforementioned materials serving as core-forming materials were placed, the pH was adjusted to 3.0 by adding 1.0% nitric acid at a temperature of 25° C., and then, while the resulting mixture was dispersed in a homogenizer (ULTRA-TURRAX T50 produced by IKA Japan) at 5,000 rpm, 100 parts of an aqueous magnesium chloride solution having a concentration of 2.0 mass % was added as an aggregating agent and dispersed for 6 minutes.

Then by using a stirring blade in a heating water bath, the mixture was heated to 53° C. while the rotation speed was adjusted as appropriate to stir the mixture. The volume average particle diameter of the formed aggregated particles was confirmed with COULTER MULTISIZER III as appropriate, the temperature was maintained when the volume average particle diameter had reached 5.0 μm, and the pH was adjusted to 9.0 with a 5% aqueous sodium hydroxide solution. Then the temperature was increased to 90° C., and 90° C. was held for 1 hour to fuse the aggregated particles.

Hydrochloric acid was added to adjust the pH at 90° C. to 5.0, followed by further stirring for 30 minutes.

Furthermore, a 0.9 mol/L aqueous Na₂CO₃ solution was added, and the pH was adjusted to 5.5 and held for 30 minutes. Then the resulting mixture was cooled to 25° C., filtered and solid-liquid separated, and washed with deionized water. A toner particle 3 having weight-average particle diameter of 7.3 μm was obtained by drying the obtained product by using vacuum drier after completion of washing.

### Production Example of Binder Resin L

polyoxypropylene(2.2)-2,2-bis(4-hydroxyphenyl)propane: 72.0 parts by mass (0.20 parts by mol; 100.0 mol % relative to the total number moles of polyhydric alcohols)
terephthalic acid: 28.0 parts by mass (0.17 parts by mol; 100.0 mol % relative to the total number of moles of polycarboxylic acids)
tin 2-ethylhexanate (esterification catalyst): 0.5 parts by mass

Into a reactor vessel equipped with a cooling tube, a stirrer, a nitrogen inlet tube, and a thermocouple, the aforementioned materials were weighed.

Next, after the inside of the reactor vessel was purged with nitrogen gas, the temperature was elevated gradually under stirring, and the reaction was carried out for 4 hours under stirring at a temperature of 200° C. Then the pressure in the reaction vessel was reduced to 8.3 kPa and maintained thereat for 1 hour, then cooling was performed to 180° C., and the pressure was returned to atmospheric.
trimellitic anhydride: 1.3 parts by mass (0.01 parts by mol; 4.0 mol % relative to the total number of moles of polycarboxylic acids)
tert-butylcatechol (polymerization inhibitor): 0.1 parts by mass

Subsequently, the aforementioned materials were added, the pressure inside the reactor vessel was reduced to 8.3 kPa, and the reaction was carried out for 1 hour while maintaining the temperature of 180° C. After confirming that the softening point measured in accordance with ASTM D36-86 had reached 90° C., the temperature was decreased to terminate the reaction to obtain a binder resin L.

### Production Example of Binder Resin H

polyoxypropylene(2.2)-2,2-bis(4-hydroxyphenyl)propane: 72.3 parts by mass (0.20 parts by mol; 100.0 mol % relative to the total number moles of polyhydric alcohols)
terephthalic acid: 18.3 parts by mass (0.11 parts by mol; 65.0 mol % relative to the total number of moles of polycarboxylic acids)
fumaric acid: 2.9 parts by mass (0.03 parts by mol; 15.0 mol % relative to the total number of moles of polycarboxylic acids)
tin 2-ethylhexanate (esterification catalyst): 0.5 parts by mass

Into a reactor vessel equipped with a cooling tube, a stirrer, a nitrogen inlet tube, and a thermocouple, the aforementioned materials were weighed.

Next, after the inside of the reactor vessel was purged with nitrogen gas, the temperature was elevated gradually under stirring, and the reaction was carried out for 2 hours under stirring at a temperature of 200° C.

Then the pressure in the reaction vessel was reduced to 8.3 kPa and maintained thereat for 1 hour, then cooling was performed to 180° C., and the pressure was returned to atmospheric.
trimellitic anhydride: 6.5 parts by mass (0.03 parts by mol; 20.0 mol % relative to the total number of moles of polycarboxylic acids)
tert-butylcatechol (polymerization inhibitor): 0.1 parts by mass

Subsequently, the aforementioned materials were added, the pressure inside the reactor vessel was reduced to 8.3 kPa, and the reaction was carried out for 15 hours while maintaining the temperature of 160° C. After confirming that the softening point measured in accordance with ASTM D36-86 had reached 137° C., the temperature was decreased to terminate the reaction to obtain a binder resin H.

### Production Example of Toner Particle 4

binder resin L: 70 parts by mass
binder resin H: 30 parts by mass
Fischer-Tropsch wax (hydrocarbon wax, the peak temperature of the maximum endothermic peak: 90° C.): 5 parts by mass
C.I. Pigment Blue 15:3: 5 parts by mass

First, the aforementioned materials were pre-mixed in a Henschel mixer and melt-kneaded by using a twin screw knead extruder. Here, the residence time was adjusted so that the temperature of the kneaded resin was 140° C. The obtained kneaded product was cooled, roughly pulverized in a hammer mill, and pulverized in a turbo mill, and the obtained fine particles were classified by using a multi-division classifier (trade name: Elbow-Jet classifier produced by Nittetsu Mining Co., Ltd.) that utilizes the Coanda effect to obtain a toner particle 4 having weight average particle diameter of 6.5 μm.

### Production Example of Toner 1

To the toner particle 1 (100.0 parts), the metal titanate compound fine particle A1 (0.30 parts), the silica fine particle B1 (0.80 parts), and the inorganic fine particle C2 (0.25 parts) were externally added as an external additive and mixed by using FM10C (NIPPON COKE & ENGINEERING. CO., LTD.). The external addition conditions were as follows: upper blade: Y0 blade, lower blade: S0 blade, interval between deflector and wall: 20 mm, rotation speed: 66.6 s⁻¹, external addition time: 10 minutes, cooling water: 20° C., at a flow rate of 10 L/min. Then the resulting mixture was sieved through a mesh having 200 μm openings to obtain a toner 1. The physical properties of the obtained toner are indicated in Tables 5-2 and 5-3.

The results of the SEM image analysis and EDX analysis on the toner 1 confirmed that the particles that mainly constituted the peak 1 were the silica fine particle B, the particles that mainly constituted the peak 2 were the inorganic fine particle C, and the particles that mainly constituted the peak 3 were the metal titanate compound fine particle A.

### Production Examples of Toners 2 to 40 and 42

Toners 2 to 40 and 42 were obtained as in Production example of toner 1 except that the combination of the toner particle and the external additive was changed as indicated in Table 5-1. The physical properties are indicated in Tables 5-2 and 5-3.

The results of the SEM image analysis and EDX analysis on the toners 2 to 37, 40, and 42 confirmed that the particles that mainly constituted the peak 1 were the silica fine particle B, the particles that mainly constituted the peak 2 were the inorganic fine particle C, and the particles that mainly constituted the peak 3 were the metal titanate compound fine particle A. The results of the SEM image analysis and EDX analysis on the toner 38 confirmed that the particles that mainly constituted the peak 1 were the silica fine particle B and the particles that mainly constituted the peak 3 were the metal titanate compound fine particle A. The results of the SEM image analysis and EDX analysis on the toner 39 confirmed that the particles that mainly constituted the peak 2 were the inorganic fine particle C, and the particles that mainly constituted the peak 3 were the metal titanate compound fine particle A.

### Production Example of Toner 41

To the toner particle 1 (100.0 parts), the titanium oxide fine particles 1 (0.30 parts), the silica fine particle B1 (0.80 parts), and the inorganic fine particle C1 (0.25 parts) were externally added as an external additive and mixed by using FM10C (NIPPON COKE & ENGINEERING. CO., LTD.). The external addition conditions were as follows: lower blade: AG blade, interval between deflector and wall: 20 mm, amount of toner particle 1 charged: 2.0 kg, rotation speed: 66.6 s⁻¹, external addition time: 10 minutes, cooling water: 20° C., at a flow rate of 10 L/min. Then the resulting mixture was sieved through a mesh having 200 μm openings to obtain a toner 41.

The physical properties of the obtained toner 41 are indicated in Tables 5-2 and 5-3.

The results of the SEM image analysis and EDX analysis on the toner 41 confirmed that the particles that mainly constituted the peak 1 were the silica fine particle B and the particles that mainly constituted the peak 2 were the inorganic fine particle C.

TABLE 5-1

| | | Metal titanate | | | | | |
|---|---|---|---|---|---|---|---|
| | | compound fine | | Silica fine | | Inorganic fine | |
| | | particle A | | particle B | | particle C | |
| | Toner | | No. of | | No. of | | No. of |
| | particle | | parts | | parts | | parts |
| | No. | No. | added | No. | added | No. | added |
| Toner 1 | 1 | 1 | 0.30 | 1 | 0.80 | 2 | 0.25 |
| Toner 2 | 1 | 2 | 0.30 | 1 | 0.80 | 1 | 0.25 |
| Toner 3 | 2 | 3 | 0.30 | 1 | 0.80 | 1 | 0.25 |
| Toner 4 | 2 | 4 | 0.30 | 1 | 0.80 | 1 | 0.25 |
| Toner 5 | 2 | 5 | 0.30 | 1 | 0.80 | 1 | 0.25 |
| Toner 6 | 2 | 6 | 0.30 | 1 | 0.80 | 1 | 0.25 |
| Toner 7 | 2 | 7 | 0.30 | 1 | 0.80 | 1 | 0.25 |
| Toner 8 | 2 | 10 | 0.05 | 1 | 1.00 | 2 | 0.25 |
| Toner 9 | 2 | 11 | 0.30 | 1 | 0.80 | 1 | 0.25 |
| Toner 10 | 2 | 12 | 0.05 | 1 | 0.80 | 1 | 0.25 |
| Toner 11 | 2 | 13 | 0.30 | 1 | 0.80 | 1 | 0.25 |
| Toner 12 | 2 | 14 | 0.30 | 1 | 0.80 | 1 | 0.25 |
| Toner 13 | 2 | 15 | 0.30 | 1 | 0.80 | 1 | 0.25 |
| Toner 14 | 2 | 16 | 0.30 | 1 | 0.80 | 1 | 0.25 |
| Toner 15 | 2 | 17 | 0.30 | 1 | 0.80 | 1 | 0.25 |
| Toner 16 | 2 | 18 | 0.30 | 1 | 0.80 | 1 | 0.25 |
| Toner 17 | 2 | 19 | 0.30 | 1 | 0.80 | 1 | 0.25 |
| Toner 18 | 2 | 22 | 0.30 | 1 | 0.80 | 1 | 0.25 |
| Toner 19 | 2 | 19 | 0.20 | 1 | 0.80 | 2 | 0.05 |
| Toner 20 | 2 | 19 | 0.30 | 1 | 1.00 | 2 | 0.05 |
| Toner 21 | 2 | 19 | 0.75 | 4 | 1.20 | 4 | 0.05 |
| Toner 22 | 2 | 10 | 0.05 | 5 | 1.00 | 2 | 0.25 |
| Toner 23 | 2 | 10 | 0.30 | 3 | 0.80 | 4 | 0.25 |
| Toner 24 | 2 | 18 | 0.20 | 2 | 0.80 | 3 | 0.10 |
| Toner 25 | 2 | 18 | 0.10 | 6 | 0.50 | 5 | 1.00 |
| Toner 26 | 2 | 19 | 0.05 | 2 | 0.80 | 1 | 0.10 |
| Toner 27 | 2 | 19 | 0.90 | 6 | 0.50 | 5 | 0.10 |
| Toner 28 | 2 | 10 | 0.30 | 2 | 0.80 | 5 | 0.10 |
| Toner 29 | 2 | 19 | 0.10 | 2 | 0.80 | 3 | 0.10 |
| Toner 30 | 3 | 19 | 0.10 | 2 | 0.80 | 3 | 0.10 |
| Toner 31 | 4 | 19 | 0.10 | 2 | 0.80 | 3 | 0.10 |
| Toner 32 | 1 | 19 | 0.10 | 2 | 0.80 | 6 | 0.10 |
| Toner 33 | 1 | 19 | 0.10 | 2 | 0.80 | 7 | 0.10 |
| Toner 34 | 1 | 8 | 0.30 | 1 | 0.80 | 1 | 0.25 |
| Toner 35 | 1 | 9 | 0.30 | 1 | 0.80 | 1 | 0.25 |
| Toner 36 | 1 | 20 | 0.30 | 1 | 0.80 | 1 | 0.25 |
| Toner 37 | 1 | 21 | 0.30 | 1 | 0.80 | 1 | 0.25 |
| Toner 38 | 1 | 1 | 0.30 | 1 | 0.80 | — | — |
| Toner 39 | 1 | 1 | 0.30 | — | — | 3 | 0.25 |
| Toner 40 | 1 | 24 | 0.30 | 1 | 0.80 | 1 | 0.25 |
| Toner 41 | 1 | — | — | 1 | 0.80 | 1 | 0.25 |
| Toner 42 | 1 | 23 | 0.30 | 1 | 0.80 | 1 | 0.25 |

TABLE 5-2

| | Peak value of Feret minimum diameter | | | | | |
|---|---|---|---|---|---|---|
| | of primary particles (nm) | | | | | |
| | D_{A} | D_{B} | D_{C} | D_{A}/D_{B} | D_{B}/D_{C} | D_{A}/D_{C} |
| Toner 1 | 35 | 20 | 75 | 1.75 | 0.27 | 0.47 |
| Toner 2 | 39 | 22 | 93 | 1.77 | 0.24 | 0.42 |
| Toner 3 | 30 | 21 | 95 | 1.43 | 0.22 | 0.32 |
| Toner 4 | 37 | 25 | 89 | 1.48 | 0.28 | 0.42 |
| Toner 5 | 35 | 19 | 88 | 1.84 | 0.22 | 0.40 |
| Toner 6 | 38 | 22 | 101 | 1.73 | 0.22 | 0.38 |
| Toner 7 | 39 | 20 | 100 | 1.95 | 0.20 | 0.39 |
| Toner 8 | 5 | 22 | 80 | 0.23 | 0.28 | 0.06 |
| Toner 9 | 50 | 23 | 86 | 2.17 | 0.27 | 0.58 |
| Toner 10 | 3 | 19 | 98 | 0.16 | 0.19 | 0.03 |
| Toner 11 | 70 | 18 | 89 | 3.89 | 0.20 | 0.79 |
| Toner 12 | 70 | 18 | 89 | 3.89 | 0.20 | 0.79 |
| Toner 13 | 70 | 18 | 89 | 3.89 | 0.20 | 0.79 |
| Toner 14 | 70 | 18 | 89 | 3.89 | 0.20 | 0.79 |
| Toner 15 | 70 | 18 | 89 | 3.89 | 0.20 | 0.79 |
| Toner 16 | 70 | 18 | 89 | 3.89 | 0.20 | 0.79 |
| Toner 17 | 70 | 18 | 89 | 3.89 | 0.20 | 0.79 |
| Toner 18 | 30 | 21 | 95 | 1.43 | 0.22 | 0.32 |
| Toner 19 | 70 | 20 | 70 | 3.50 | 0.29 | 1.00 |
| Toner 20 | 70 | 20 | 70 | 3.50 | 0.29 | 1.00 |
| Toner 21 | 70 | 30 | 300 | 2.33 | 0.10 | 0.23 |
| Toner 22 | 5 | 40 | 70 | 0.13 | 0.57 | 0.07 |
| Toner 23 | 5 | 12 | 300 | 0.42 | 0.04 | 0.02 |
| Toner 24 | 50 | 5 | 50 | 10.00 | 0.10 | 1.00 |
| Toner 25 | 50 | 100 | 990 | 0.50 | 0.10 | 0.05 |
| Toner 26 | 70 | 7 | 100 | 10.00 | 0.07 | 0.70 |
| Toner 27 | 70 | 100 | 990 | 0.70 | 0.10 | 0.07 |
| Toner 28 | 5 | 5 | 1000 | 1.00 | >0.01 | >0.01 |
| Toner 29 | 70 | 5 | 50 | 14.00 | 0.10 | 1.40 |
| Toner 30 | 70 | 5 | 50 | 14.00 | 0.10 | 1.40 |
| Toner 31 | 70 | 5 | 50 | 14.00 | 0.10 | 1.40 |
| Toner 32 | 70 | 5 | 200 | 14.00 | 0.03 | 0.35 |
| Toner 33 | 70 | 5 | 300 | 14.00 | 0.02 | 0.23 |
| Toner 34 | 27 | 20 | 102 | 1.35 | 0.20 | 0.26 |
| Toner 35 | 39 | 21 | 93 | 1.86 | 0.23 | 0.42 |
| Toner 36 | 30 | 20 | 100 | 1.50 | 0.20 | 0.30 |
| Toner 37 | 30 | 21 | 103 | 1.43 | 0.20 | 0.29 |
| Toner 38 | 35 | 25 | — | 1.40 | — | — |
| Toner 39 | 30 | — | 55 | — | — | 0.55 |
| Toner 40 | 35 | 20 | 101 | 1.75 | 0.20 | 0.35 |
| Toner 41 | — | 20 | 101 | — | 0.20 | — |
| Toner 42 | 38 | 22 | 101 | 1.73 | 0.22 | 0.38 |

TABLE 5-3

| | Coverage ratio (area %) | | | | | |
|---|---|---|---|---|---|---|
| | S_{A} | S_{B} | S_{C} | S_{A}/S_{B} | S_{B}/S_{C} | S_{A}/S_{C} |
| Toner 1 | 4.7 | 42.4 | 3.5 | 0.11 | 12.11 | 1.34 |
| Toner 2 | 4.6 | 42.8 | 3.1 | 0.11 | 13.81 | 1.48 |
| Toner 3 | 5.8 | 43.0 | 2.9 | 0.13 | 14.83 | 2.00 |
| Toner 4 | 5.5 | 42.2 | 3.7 | 0.13 | 11.41 | 1.49 |
| Toner 5 | 4.4 | 43.0 | 2.9 | 0.10 | 14.83 | 1.52 |
| Toner 6 | 4.8 | 43.0 | 2.9 | 0.11 | 14.83 | 1.66 |
| Toner 7 | 4.3 | 43.2 | 2.7 | 0.10 | 16.00 | 1.59 |
| Toner 8 | 4.9 | 43.0 | 2.9 | 0.11 | 14.83 | 1.69 |
| Toner 9 | 3.8 | 42.4 | 3.5 | 0.09 | 12.11 | 1.09 |
| Toner 10 | 8.9 | 43.3 | 2.6 | 0.21 | 16.65 | 3.42 |
| Toner 11 | 2.1 | 43.2 | 2.7 | 0.05 | 16.00 | 0.78 |
| Toner 12 | 2.2 | 43.2 | 2.7 | 0.05 | 16.00 | 0.81 |
| Toner 13 | 2.1 | 43.2 | 2.7 | 0.05 | 16.00 | 0.78 |
| Toner 14 | 2.3 | 43.2 | 2.7 | 0.05 | 16.00 | 0.85 |
| Toner 15 | 2.1 | 43.2 | 2.7 | 0.05 | 16.00 | 0.78 |
| Toner 16 | 2.0 | 43.2 | 2.7 | 0.05 | 16.00 | 0.74 |
| Toner 17 | 2.0 | 43.2 | 2.7 | 0.05 | 16.00 | 0.74 |
| Toner 18 | 5.8 | 43.0 | 2.9 | 0.13 | 14.83 | 2.00 |
| Toner 19 | 1.7 | 45.1 | 0.8 | 0.04 | 56.38 | 2.13 |
| Toner 20 | 2.0 | 45.3 | 0.6 | 0.04 | 75.50 | 3.33 |
| Toner 21 | 6.3 | 45.4 | 0.5 | 0.14 | 90.80 | 12.60 |
| Toner 22 | 6.4 | 41.5 | 4.4 | 0.15 | 9.43 | 1.45 |
| Toner 23 | 3.2 | 42.2 | 3.7 | 0.08 | 11.41 | 0.86 |
| Toner 24 | 1.0 | 45.4 | 0.5 | 0.02 | 90.80 | 2.00 |
| Toner 25 | 0.8 | 38.2 | 7.7 | 0.02 | 4.96 | 0.10 |
| Toner 26 | 0.4 | 50.0 | 1.6 | >0.01 | 31.25 | 0.25 |
| Toner 27 | 8.9 | 30.0 | 0.4 | 0.30 | 75.00 | 22.25 |
| Toner 28 | 4.9 | 43.0 | 2.9 | 0.11 | 14.83 | 1.69 |
| Toner 29 | 2.1 | 43.2 | 2.7 | 0.05 | 16.00 | 0.78 |
| Toner 30 | 2.1 | 43.2 | 2.7 | 0.05 | 16.00 | 0.78 |
| Toner 31 | 2.1 | 43.2 | 2.7 | 0.05 | 16.00 | 0.78 |
| Toner 32 | 2.1 | 43.2 | 1.0 | 0.05 | 43.20 | 2.10 |
| Toner 33 | 2.1 | 43.2 | 0.8 | 0.05 | 54.00 | 2.63 |
| Toner 34 | 6.1 | 43.3 | 2.6 | 0.14 | 16.65 | 2.35 |
| Toner 35 | 4.5 | 42.9 | 3.0 | 0.10 | 14.30 | 1.50 |
| Toner 36 | 4.5 | 42.9 | 3.0 | 0.10 | 14.30 | 1.50 |
| Toner 37 | 4.5 | 42.9 | 3.0 | 0.10 | 14.30 | 1.50 |
| Toner 38 | 6.0 | 52.0 | — | 0.12 | — | — |
| Toner 39 | 7.0 | — | 6.0 | — | — | 1.17 |
| Toner 40 | 4.5 | 42.9 | 3.0 | 0.10 | 14.30 | 1.50 |
| Toner 41 | — | 42.9 | 3.0 | — | 14.30 | — |
| Toner 42 | 4.8 | 43.0 | 2.9 | 0.11 | 14.83 | 1.66 |

### Examples 1 to 33 and Comparative Examples 1 to 9

The toners 1 to 42 were used for evaluation under the conditions described below. The evaluation results are indicated in Table 6. HP Color LaserJet Enterprise M653 in which the process speed was modified to 410 mm/see was used as an evaluation machine. Vitality (produced by Xerox Corporation, grammage: 75 g/cm², letter size) was used as the paper for evaluation.

### Evaluation of Charge Rising Property in High-Temperature, High-Humidity Environment

In a high-temperature, high-humidity environment of 32.5° C./80% RH, the evaluation machine and toner cartridges filled with evaluation toners were left to stand for at least a day, and a test chart (letter portrait) having a printing ratio of 1% was output by the evaluation machine on 1000 sheets. After outputting 1000 sheets, the charge amount (μC/g) of the toner on the developer bearing member in the toner cartridge was measured by using a blow-off powder charge measurement device TB-200 (Toshiba Chemical Corp.). The charge amount of the obtained toner was assumed to be C1 (μC/g).

Subsequently, the evaluation machine was left to stand in the same environment for 72 hours, and a test chart (letter portrait) having a printing ratio of 1% was output by the evaluation machine on 100 sheets. After outputting 100 sheets, the charge amount (μC/g) of the toner on the developer bearing member in the toner cartridge was measured by using a blow-off powder charge measurement device TB-200 (Toshiba Chemical Corp.). The charge amount of the obtained toner was assumed to be C2 (μC/g).

The ratio (%) of C2 to C1 was calculated by using the obtained C1 and C2, and the charge rising property was evaluated according to the following standard. The higher the ratio (%) of C2 to C1, the better the charge rising property of the toner.

### Evaluation Standard

A: 95% or higher
B: 90% or higher and lower than 95%
C: 85% or higher and lower than 90%
D: lower than 85%

### Evaluation of Charge Maintaining Property in High-Temperature, High-Humidity Environment

In a high-temperature, high-humidity environment of 32.5° C./80% RH, the evaluation machine and toner cartridges filled with evaluation toners were left to stand for at least a day, and a test chart (letter portrait) having a printing ratio of 1% was output by the evaluation machine on 100 sheets. After outputting 100 sheets, the charge amount (μC/g) of the toner on the developer bearing member in the toner cartridge was measured by using a blow-off powder charge measurement device TB-200 (Toshiba Chemical Corp.). The charge amount of the obtained toner was assumed to be the initial charge amount C3 (μC/g).

Subsequently, a test chart (letter portrait) having a printing ratio of 1% was output by the evaluation machine on 50000 sheets. After outputting 50000 sheets, the charge amount (μC/g) of the toner on the developer bearing member in the toner cartridge was measured by using a blow-off powder charge measurement device TB-200 (Toshiba Chemical Corp.). The charge amount of the obtained toner was assumed to be the post-endurance charge amount C4 (μC/g).

The difference (C3−C4) between the initial charge amount and the post-endurance charge amount was calculated by using obtained C3 and C4, and the charge maintaining property was evaluated according to the following standard.

### Evaluation Standard

AA: The difference between the initial charge amount and the post-endurance charge amount was less than 1.0 μC/g.
A: The difference between the initial charge amount and the post-endurance charge amount was 1.0 μC/g or more and less than 1.5 μC/g.
B: The difference between the initial charge amount and the post-endurance charge amount was 1.5 μC/g or more and less than 2.5 μC/g.
C: The difference between the initial charge amount and the post-endurance charge amount was 2.5 μC/g or more and less than 4.5 μC/g.
D: The difference between the initial charge amount and the post-endurance charge amount was 4.5 μC/g or more.

### Evaluation of Streaks in Sheet Feed Direction in High-Temperature, High-Humidity Environment

In a high-temperature, high-humidity environment of 32.5° C./80% RH, the evaluation machine and toner cartridges filled with evaluation toners were left to stand for at least a day, and a transverse line image having a printing ratio of 0.1% was output by the evaluation machine on 100,000 sheets. During this process, one a full-sheet solid image (letter portrait) was output each time the transverse line image having a printing ratio of 0.1% was output on 5,000 sheets. The output solid image was observed with naked eye, and the streaks in the sheet feed direction was evaluated by the following standard.

### Evaluation Standard

A: No streaks in the sheet feed direction were observed in the solid image until after the transverse line image was output on 100,000 sheets.
B: No streaks in the sheet feed direction were observed in the solid image until after the transverse line image was output on 80,000 sheets, and streaks were observed in the solid image after outputting 85,000 to 100,000 sheets.
C: No streaks in the sheet feed direction were observed in the solid image until after the transverse line image was output on 50,000 sheets, and streaks were observed in the solid image after outputting 55,000 to 80,000 sheets.
D: No streaks in the sheet feed direction were observed in the solid image until after the transverse line image was output on 10,000 sheets, and streaks were observed in the solid image after outputting 15,000 to 50,000 sheets.

### Evaluation of Uneven Density in Sheet Feed Direction and Solid Image Evenness

In a high-temperature, high-humidity environment of 32.5° C./80% RH, the evaluation machine and toner cartridges filled with evaluation toners were left to stand for at least a day, and a horizontal line image (letter portrait) was output on 4,000 sheets in an intermittent mode (an 8 second pause every two output sheets). Here, a horizontal line image is an image in which three-dot line images in a direction perpendicular to the sheet feed direction are arranged at 180-dot intervals in the sheet feed direction.

Immediately after the end of the outputs described above, a halftone image (letter portrait, 30H image) and full-sheet solid image (letter landscape) were output. Here, a 30H image is a value hexadecimally indicating 256 levels and is a halftone image when 00H indicates solid white (no image) and FFH indicates a full-sheet solid image. For the output halftone image, whether there was uneven density in the sheet feed direction (portions where the concentration was low in the form of streaks in the sheet feed direction) was checked by naked eye. Furthermore, the output full-sheet solid image was divided into 9 areas (divided in 3 in the longitudinal direction and in 3 in the transverse direction) and a reflection density meter (Color reflection densitometer X-Rite 404A: produced by X-Rite, Incorporated) was used to measure the image density of the center portion of each area. The difference between the maximum value and the minimum value of the image densities at 9 points was calculated and was assumed to be the maximum density difference. The sheet feed direction uneven density and the solid image evenness were evaluated according to the following standard.

### Standard for Evaluating Sheet Feed Direction Uneven Density

A: No uneven density in the sheet feed direction was observed in the halftone image.
B: An uneven density in the sheet feed direction was observed in one spot in the halftone image.
C: An uneven density in the sheet feed direction was observed in two or three spots in the halftone image.
D: An uneven density in the sheet feed direction was observed in four or more spots in the halftone image.

### Standard for Evaluating Solid Image Evenness

A: The maximum density difference in the solid image was less than 0.04.
B: The maximum density difference in the solid image was 0.04 or more and less than 0.15.
C: The maximum density difference in the solid image was 0.15 or more and less than 0.30.
D: The maximum density difference in the solid image was 0.30 or more.

TABLE 6

| | | | | Difference between | | | |
|---|---|---|---|---|---|---|---|
| | | | | initial charge amount | | Uneven | |
| | | Charge | Charge | and post-endurance | Streaks in | density in | Solid |
| | | rising | maintaining | charge amount | sheet feed | sheet feed | image |
| | Toner | property | property | (−μC/g) | direction | direction | evenness |
| Example 1 | Toner 1 | A | AA | 0.4 | A | A | A |
| Example 2 | Toner 2 | A | AA | 0.5 | A | A | A |
| Example 3 | Toner 3 | A | AA | 0.5 | A | B | A |
| Example 4 | Toner 4 | A | AA | 0.9 | A | A | A |
| Example 5 | Toner 5 | A | A | 1.2 | A | A | A |
| Example 6 | Toner 6 | A | AA | 0.8 | B | A | A |
| Example 7 | Toner 7 | A | AA | 0.7 | A | A | A |
| Example 8 | Toner 8 | A | AA | 0.9 | A | B | A |
| Example 9 | Toner 9 | A | AA | 0.8 | B | B | A |
| Example 10 | Toner 10 | A | A | 1.1 | B | A | A |
| Example 11 | Toner 11 | A | A | 1.3 | B | B | A |
| Example 12 | Toner 12 | A | A | 1.4 | B | B | A |
| Example 13 | Toner 13 | A | A | 1.5 | B | B | A |
| Example 14 | Toner 14 | A | A | 1.3 | B | B | A |
| Example 15 | Toner 15 | A | A | 1.5 | B | C | B |
| Example 16 | Toner 16 | A | B | 2.0 | B | C | B |
| Example 17 | Toner 17 | B | B | 2.0 | B | C | A |
| Example 18 | Toner 18 | A | B | 1.7 | B | B | A |
| Example 19 | Toner 19 | B | B | 2.3 | C | B | B |
| Example 20 | Toner 20 | B | B | 2.5 | C | B | B |
| Example 21 | Toner 21 | B | B | 2.4 | C | C | C |
| Example 22 | Toner 22 | A | A | 1.1 | B | B | A |
| Example 23 | Toner 23 | A | A | 1.2 | B | B | A |
| Example 24 | Toner 24 | B | C | 3.0 | C | C | B |
| Example 25 | Toner 25 | B | B | 2.5 | B | C | C |
| Example 26 | Toner 26 | C | C | 3.1 | C | C | C |
| Example 27 | Toner 27 | C | C | 3.2 | C | C | C |
| Example 28 | Toner 28 | C | C | 3.5 | C | C | B |
| Example 29 | Toner 29 | C | C | 2.9 | C | C | C |
| Example 30 | Toner 30 | C | C | 3.1 | C | C | C |
| Example 31 | Toner 31 | C | C | 3.4 | C | C | C |
| Example 32 | Toner 32 | C | C | 4.1 | C | C | C |
| Example 33 | Toner 33 | C | C | 4.3 | C | C | C |
| Comparative | Toner 34 | C | D | 4.6 | D | C | C |
| Example 1 | | | | | | | |
| Comparative | Toner 35 | D | D | 4.8 | C | D | C |
| Example 2 | | | | | | | |
| Comparative | Toner 36 | C | C | 4.4 | D | C | C |
| Example 3 | | | | | | | |
| Comparative | Toner 37 | C | C | 4.3 | D | C | C |
| Example 4 | | | | | | | |
| Comparative | Toner 38 | D | D | 6.1 | B | C | B |
| Example 5 | | | | | | | |
| Comparative | Toner 39 | D | C | 4.4 | C | C | C |
| Example 6 | | | | | | | |
| Comparative | Toner 40 | D | C | 4.0 | C | D | D |
| Example 7 | | | | | | | |
| Comparative | Toner 41 | C | D | 5.0 | B | B | C |
| Example 8 | | | | | | | |
| Comparative | Toner 42 | C | D | 4.8 | C | C | B |
| Example 9 | | | | | | | |

According to the present disclosure, it becomes possible to provide a toner that can maintain charge stability and good transferability and achieve stable image quality despite long-term use at a low printing ratio in a high-temperature, high-humidity environment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176793, filed Oct. 8, 2024, which is hereby incorporated by reference herein in its entirety.

What is claimed is:

1. A toner comprising:
a toner particle comprising a binder resin and a release agent; and
an external additive on a surface of the toner particle, wherein:
the external additive comprises:
a metal titanate compound fine particle A,
a silica fine particle B, and
an inorganic fine particle C,
in time-of-flight secondary ion mass spectrometry using the metal titanate compound fine particle A as a sample, a fragment ion corresponding to a structure represented by formula (1) is observed,
in a ²⁹Si-NMR spectrum obtained by a solid-state ²⁹Si-NMR CP/MAS method using the metal titanate compound fine particle A as a sample,
(i) a peak D assigned to a D unit structure is present in a range of −25 ppm to −15 ppm,
(ii) a peak X2 assigned to an X2 unit structure represented by formula (2) below is present in a range of −60 ppm to −50 ppm,
(iii) a peak X3 assigned to an X3 unit structure represented by formula (3) below is present in a range of −70 ppm to −60 ppm, and
(iv) S_{D}/(S_{X2}+S_{X3}) is 0.10 to 1.50 where S_{D} represents an area of the peak D, S_{X2} represents an area of the peak X2, and S_{X3} represents an area of the peak X3,
the inorganic fine particle C is a fine particle selected from the group consisting of a silica fine particle C, an alumina fine particle C, and a titania fine particle C,
in a graph based on a particle size distribution of silica fine particles obtained by combining SEM image analysis and EDX analysis on a surface of the toner, the graph having a horizontal axis indicating a Feret minimum diameter of primary particles and a vertical axis indicating a frequency, a peak 1 having a peak value in a Feret minimum diameter range of 5 to 100 nm and being mainly constituted by the silica fine particle B is observed, and
in a graph based on a particle size distribution of the external additive obtained by combining SEM image analysis and EDX analysis on the surface of the toner, the graph having a horizontal axis indicating a Feret minimum diameter of primary particles and a vertical axis indicating a frequency, a peak 2 having a peak value that is present in a Feret minimum diameter range of 50 to 1000 nm and on a large particle diameter side of the peak value of the peak 1, and being mainly constituted by the inorganic fine particle C is observed, 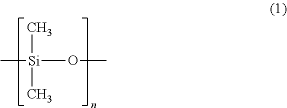
in formula (1), n represents an integer of 2 or more, 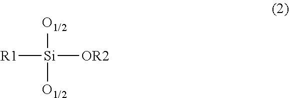
in formula (2), R1 represents a hydrocarbon group having 1 to 10 carbon atoms, R2 represents a hydrogen atom or a hydrocarbon group having 1 to 10 carbon atoms, and O_{1/2} represents an oxygen atom shared with an adjacent Si atom or Ti atom, 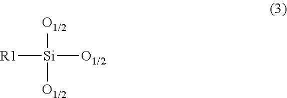
in formula (3), R1 represents a hydrocarbon group having 1 to 10 carbon atoms, and 012 represents an oxygen atom shared with an adjacent Si atom or Ti atom.

2. The toner according to claim 1, wherein, in a graph based on a particle size distribution of metal titanate compound fine particles obtained by combining SEM image analysis and EDX analysis on the surface of the toner, the graph having a horizontal axis indicating a Feret minimum diameter of primary particles and a vertical axis indicating a frequency, a peak 3 having a peak value in a Feret minimum diameter range of 0.5 to 1000 nm and being mainly constituted by the metal titanate compound fine particle A is observed, and
D_{A} (nm) representing a peak value of the peak 3, D_{B} (nm) representing a peak value of the peak 1, and D_{C} (nm) representing a peak value of the peak 2 satisfy:
$$0.1 \leq {D}_{A} / {D}_{B} \leq 10 \text{.00}$$
$$0.01 \leq {D}_{B} / {D}_{C} \leq 0 \text{.80}$$
$$0.01 \leq {D}_{A} / {D}_{C} \leq 1. .$$

3. The toner according to claim 1, wherein, S_{A} representing a coverage ratio (area %) of the toner particle by the metal titanate compound fine particle A, S_{B} representing a coverage ratio (area %) of the toner particle by the silica fine particle B, and S_{C} representing a coverage ratio (area %) of the toner particle by the inorganic fine particle C satisfy:
$$0.01 \leq {S}_{A} / {S}_{B} \leq 0 \text{.30}$$
$$1. \leq {S}_{B} / {S}_{C} \leq 80.$$
$$0.3 \leq {S}_{A} / {S}_{C} \leq 22.00$$

4. The toner according to claim 1, wherein S_{X2} and S_{X3} satisfy S_{X2}≤S_{X3}.

5. The toner according to claim 1, wherein the metal titanate compound fine particle A is a strontium titanate fine particle.

6. The toner according to claim 1, wherein the metal titanate compound fine particle A is a surface-treated product with a silane coupling agent and a silicone oil.

7. The toner according to claim 6, wherein the silane coupling agent is an alkyltrialkoxysilane having an alkyl group having 3 to 6 carbon atoms.

8. The toner according to claim 1, wherein, in a graph based on a particle size distribution of metal titanate compound fine particles obtained by combining SEM image analysis and EDX analysis on the surface of the toner, the graph having a horizontal axis indicating a Feret minimum diameter of primary particles and a vertical axis indicating a frequency, a peak 3 having a peak value in a Feret minimum diameter range of 0.5 to 1000 nm and being mainly constituted by the metal titanate compound fine particle A is observed, and
a peak value D_{A} (nm) of the peak 3 is 5 to 50 nm.
